(19) United States
(12) Patent Application Publication
(10) Pub. No.: US 2002/0040305 A1
(43) Pub. Date: Apr. 4, 2002

(54) Apparatus, system and method for managing diagnostic information

(76) Inventors: Kazutaka Nakatsuchi, Tokyo (JP); Koji Takamura, Sagamihara-shi (JP)

Correspondence Address: Scully, Scott, Murphy & Presser, 400 Garden City Plaza, Garden City, NY, 11530, US

(21) Appl. No.: 09/907,085

(22) Filed: Jul. 17, 2001

(30) Foreign Application Priority Data
Jul. 19, 2000 (JP) 2000-219469

(51) Int. Cl. G06F 17/60

(52) U.S. Cl. 705/2; 705/8

(57) ABSTRACT

After getting access to a hospital terminal from a patient terminal via a host computer of a medical care information managing apparatus, and browsing an appointment-status database of the hospital terminal to find an available appointment, a patient may make an appointment. A doctor accesses the host computer during or after a medical examination, and records the medical examination result and the prescription in a directory area for the patient, which is formed in a patient information database. The prescription information is transmitted to a terminal in a pharmacy in the patient's neighborhood or to a specified pharmacy. Accordingly, after completion of the medical examination, the patient can go home without having to wait to receive the prescription, and can receive medicine from the pharmacy. This reduces the patient's waiting time before and after the medical examination at the hospital.

This application claims benefit of Japanese Application Number 2000-219469 filed in Japan on Jul. 19, 2000, the contents of which are incorporated by this reference.

### BACKGROUND OF THE INVENTION

1. Field of the Invention

The present invention relates to a medical care information managing apparatus, a medical care information managing system, and a medical care information managing method. More particularly, the present invention relates to a medical care information managing apparatus, a medical care information managing system, and a medical care information managing method which are capable of searching information specific to a hospital and of making an appointment for medical care at a specified hospital via a communication line.

2. Description of the Related Art

Generally, a hospital appointment for a medical examination is performed when a patient individually presumes that he/she is afflicted with a disease or suffers an injury, searches for a hospital where he/she can consult a doctor, and makes an appointment by telephone or at the hospital.

In this case, it is necessary that the patient find a hospital where he/she can consult a doctor by asking other people or by consulting a telephone book. The patient must spend a great deal of effort to select a hospital, to find the location of the hospital, and to make an appointment at the hospital before consulting a doctor. The series of processes are very complicated.

Also, the patient must sometimes go to the hospital to make an appointment for a medical examination, and may have to wait several hours before receiving the medical examination without an appointment.

Also, when going to a new hospital, not only is lot of energy spent to select one, but the series of processes required to find out the address of the hospital and to make an appointment are very complicated.

In order to solve the above problems, a technique is disclosed in Japanese Unexamined Patent Application Publication No. 10-149391, in which a patient can make an appointment at a hospital online from a distant place such as a home by using an IC card. Specifically, a patient's health insurance number, an address, and a telephone number and the like are stored in the IC card in advance. When making an appointment at a hospital by inserting the IC card into a telephone set and pushing an appointment start button, the telephone is connected to a host computer of a regional hospital managing center for managing regional hospitals, and information registered in the IC card is sent to the host computer. The host computer selects a candidate hospital for a medical examination on the basis of the information having been sent, and displays the selected hospitals on a display of the telephone. When the patient selects a hospital from the hospitals displayed on the telephone display, the appointment at the hospital is completed and the appointment information is stored in the IC card.

However, in the above-described related art, the patient must go to a place where an appointment-specific telephone is installed in order to make an appointment. Accordingly, making an appointment of a medical examination is not easy. Also, installing the appointment-specific telephone at home places a financial burden on the patient.

Also, since patient information is stored in the IC card, it is necessary to store an IC card for each hospital, and thus they are difficult to manage.

In addition, since the patient must stay at the hospital after medical examination until he/she receives a medical prescription and pays the hospital fee, he/she does not have free use of the time after the medical examination.

### SUMMARY OF THE INVENTION

Accordingly, in consideration of the above situations, it is an object of the present invention to provide a medical care information managing apparatus capable of minimizing a patient's waiting time before and after a medical examination at a hospital.

In order to achieve the above object, a medical care information managing apparatus according to the present invention includes a hospital-specific information storing unit for storing information specific to a hospital; a hospital search requirement receiving unit for receiving a search requirement signal for the hospital-specific information which is stored in the hospital-specific information storing unit via a communication line; a hospital-specific information searching unit for searching the information specific to the hospital, which is stored in the hospital-specific information storing unit, on the basis of the search requirement signal received by the hospital search requirement receiving unit; and a hospital-specific information transmitting unit for transmitting the result of a search by the hospital-specific information searching unit to the origin of the search requirement signal received by the hospital search requirement receiving unit via the communication line. The medical care information managing apparatus further includes an appointment requirement receiving unit for receiving an appointment requirement signal for a specified hospital specified on the basis of the search result by the hospital-specific information searching unit via the communication line; an appointment processing unit for performing appointment processing for a patient for the hospital on the basis of the appointment requirement signal received by the appointment requirement receiving unit; and a medical care information storing unit for storing medical care information created on the basis of a medical care for the patient for whom the appointment processing is performed by the appointment processing unit.

The above and further objects and features of the invention will more fully be apparent from the following detailed description with accompanying drawings.

### BRIEF DESCRIPTION OF THE DRAWINGS

FIG. 1 is a block diagram showing a medical care information managing system according to a first embodiment of the present invention;

FIG. 2 is a typical view showing a flow of a medical care information managing system according to the first embodiment of the present invention;

FIG. 3 is an explanation drawing illustrating a directory construction of a patient information data base according to the first embodiment of the present invention;

FIG. 4 is an explanation drawing illustrating a directory construction of a hospital information data base according to the first embodiment of the present invention;

FIG. 5 is an explanation drawing illustrating a directory construction of a medical prescription information data base according to the first embodiment of the present invention;

FIG. 6 is an explanation drawing illustrating a directory construction of an appointment status data base according to the first embodiment of the present invention;

FIG. 7 is a flowchart (1) showing a procedure that a patient has access to a host computer according to the first embodiment of the present invention;

FIG. 8 is a flow chart (2) showing a procedure that a patient has access to a host computer according to the first embodiment of the present invention;

FIG. 9 is a flow chart (3) showing a procedure that a patient has access to a host computer according to the first embodiment of the present invention;

FIG. 10 is a flow chart (4) showing a procedure that a patient has access to a host computer according to the first embodiment of the present invention;

FIG. 11 is a flow chart (5) showing a procedure that a patient has access to a host computer according to the first embodiment of the present invention;

FIG. 12 is a flow chart (6) showing a procedure that a patient has access to a host computer according to the first embodiment of the present invention;

FIG. 13 is a flow chart (1) showing a medical care result/a medical prescription information registration procedure according to the first embodiment of the present invention;

FIG. 14 is a flowchart (2) showing a medical care result/a medical prescription information registration procedure according to the first embodiment of the present invention;

FIG. 15 is a flow chart (1) showing a medical care/ a medical prescription cost registration procedure according to the first embodiment of the present invention;

FIG. 16 is a flow chart (2) showing a medical care/ a medical prescription cost registration procedure according to the first embodiment of the present invention;

FIG. 17 is an explanation drawing illustrating a layer of an image to be indicated on a monitor according to the first embodiment of the present invention;

FIG. 18 is an explanation drawing showing a “LOG IN” screen according to the first embodiment of the present invention;

FIG. 19 is an explanation drawing showing a “new member registration (1)” screen according to the first embodiment of the present invention;

FIG. 20 is an explanation drawing showing a “new member registration (2)” screen according to the first embodiment of the present invention;

FIG. 21 is an explanation drawing showing a “main menu” screen according to the first embodiment of the present invention;

FIG. 22 is an explanation drawing showing a “hospital search key word” input screen according to the first embodiment of the present invention;

FIG. 23 is an explanation drawing showing a “search result” indicating screen according to the first embodiment of the present invention;

FIG. 24 is an explanation drawing showing a “search result” list indicating screen according to the first embodiment of the present invention;

FIG. 25 is an explanation drawing showing a “detailed information on each hospital” indicating screen according to the first embodiment of the present invention;

FIG. 26 is an explanation drawing showing a “specifying a hospital for an appointment” screen according to the first embodiment of the present invention;

FIG. 27 is an explanation drawing showing a “new appointment” screen according to the first embodiment of the present invention according to the first embodiment of the present invention;

FIG. 28 is an explanation drawing showing a “notification of appointment completion” screen according to the first embodiment of the present invention;

FIG. 29 is an explanation drawing showing a “specifying apatient” screen according to the first embodiment of the present invention;

FIG. 30 is an explanation drawing showing a “medical care result/medical prescription information registration” screen according to the first embodiment of the present invention;

FIG. 31 is an explanation drawing showing a “medical care/medical prescription cost registration” screen according to the first embodiment of the present invention;

FIG. 32 is a block diagram showing a medical care information managing system according to a second embodiment of the present invention; and

FIG. 33 is an explanation drawing showing a directory construction of a data base arranged in storing means of a host computer according to the second embodiment of the present invention.

### DESCRIPTION OF THE PREFERRED EMBODIMENTS

A first embodiment according to the present invention will be explained on the basis of drawings.

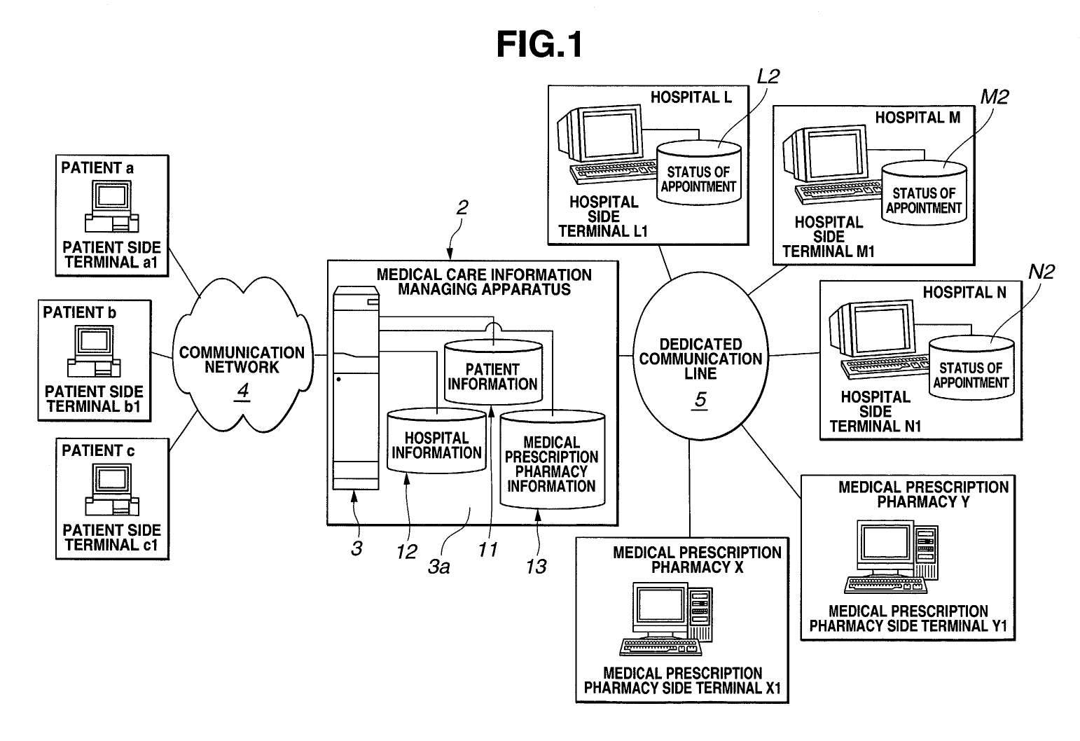

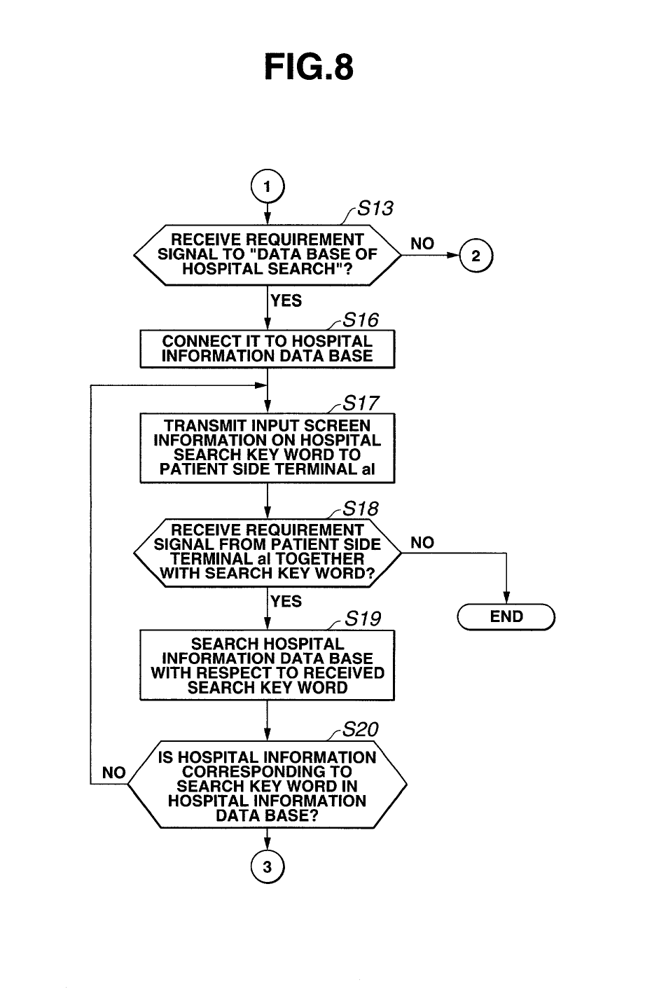

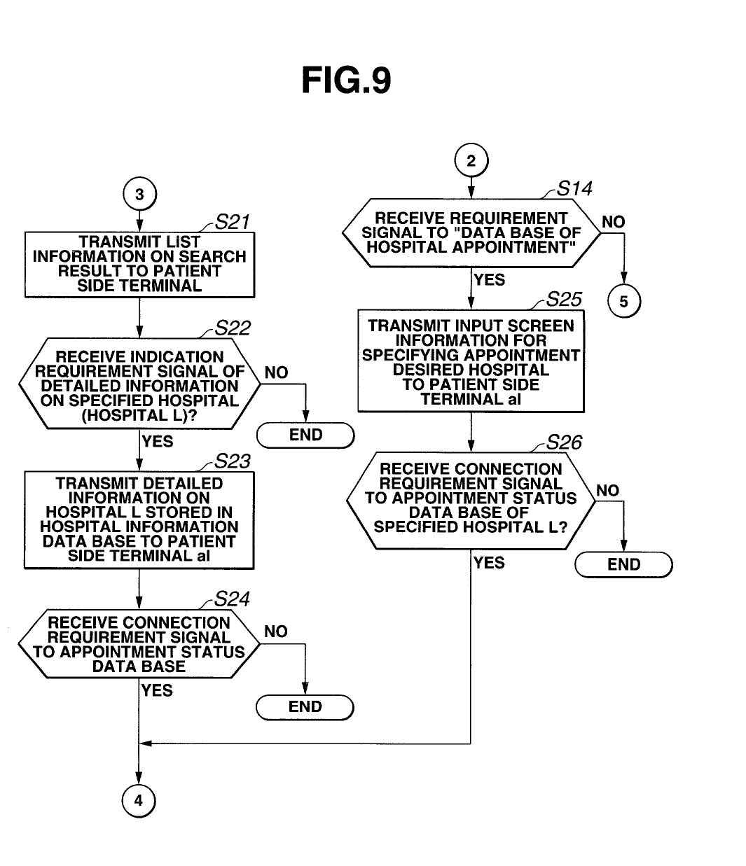

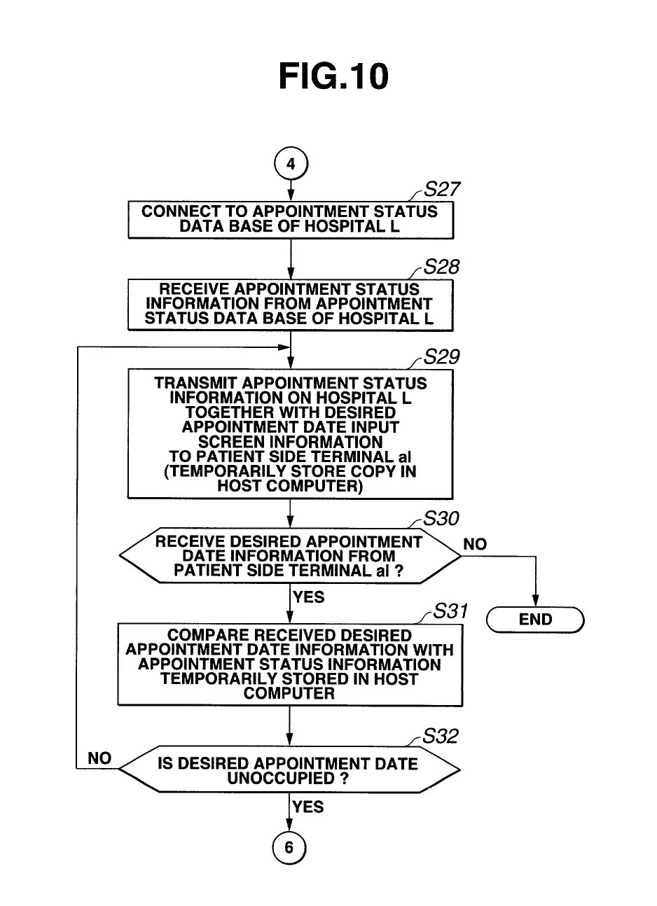

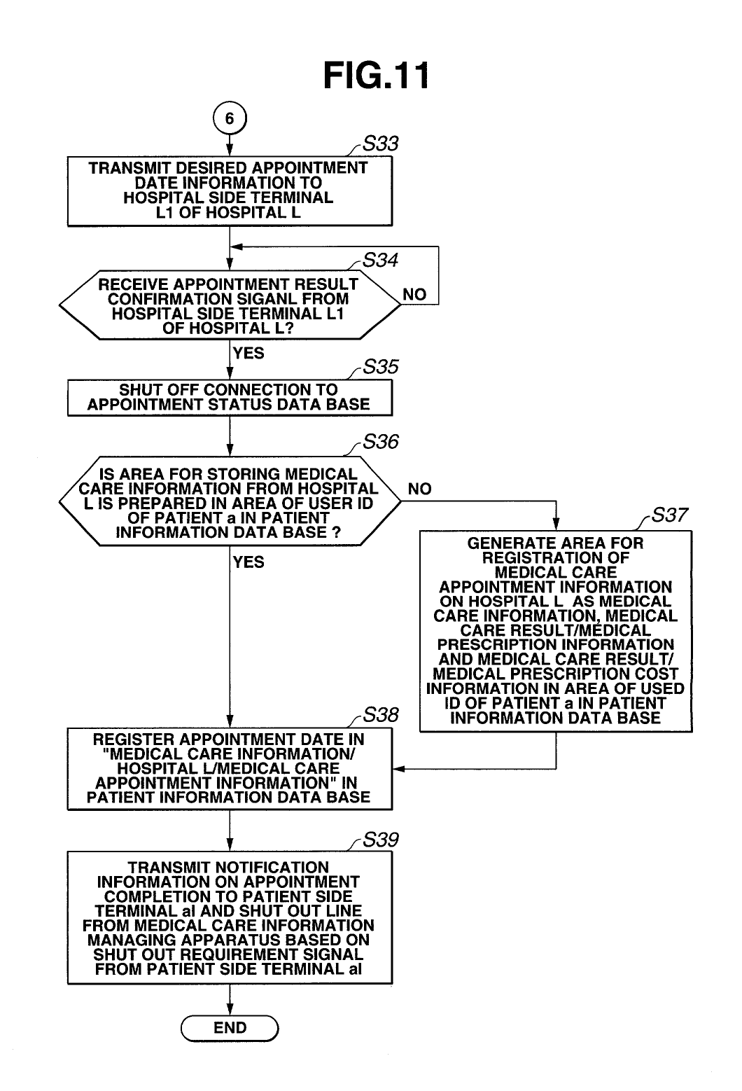

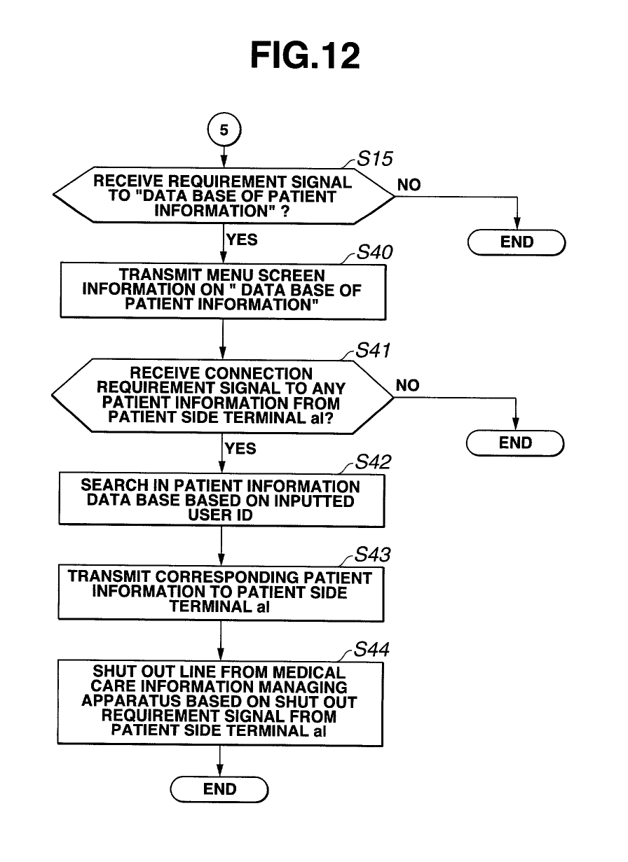

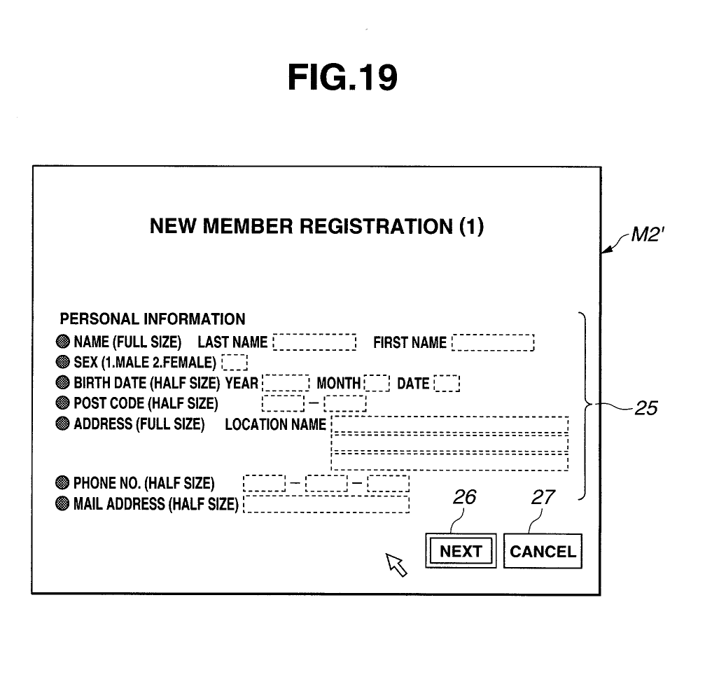

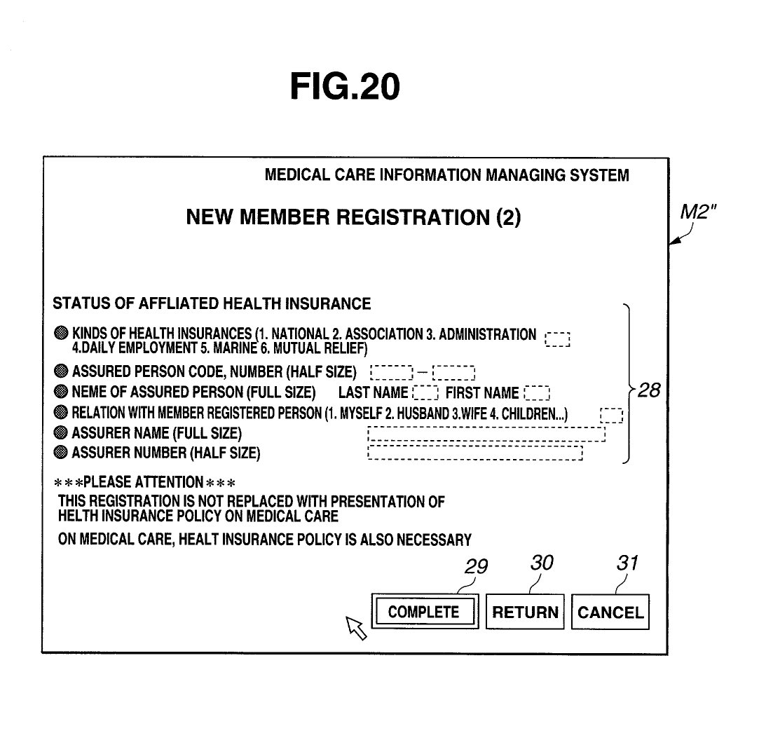

FIGS. 1-31 illustrate a first embodiment according to the present invention. FIG. 1 is a block diagram showing a medical care information managing system. It is assumed for convenience that the number of patients and the number of hospitals are three respectively and the number of medical prescription pharmacy is two, in the following explanation. However, it is no problem that the numbers are larger than the assumption.

As shown in these drawings, patient side terminals a1, b1, c1, which are arranged at patients a, b, c's home or the like such as personal computers or the like, are connected to a host computer 3, which is installed in a medical care information managing apparatus 2 via a communication network 4 such as the Internet or the like which open outside. Further, this host computer 3 is connected via a closed dedicated communication line 5 to hospital side terminals L1, M1, N1 and medical prescription pharmacy side terminals X1, Y1 such as personal computers or the like which are respectively arranged in specified hospitals L, M, N and specified medical prescription pharmacies X, Y, which were registered beforehand.

Storing means 3a of the host computer 3 houses a patient information data base 11 storing registered patient's private information, a hospital information data base 12 storing registered information on each hospital and a medical prescription pharmacy information data base 13 storing registered respective medical prescription pharmacy information. This medical care information managing apparatus 2 may be arranged either in representative places or in the other dedicated places in respective hospitals L, M and N.

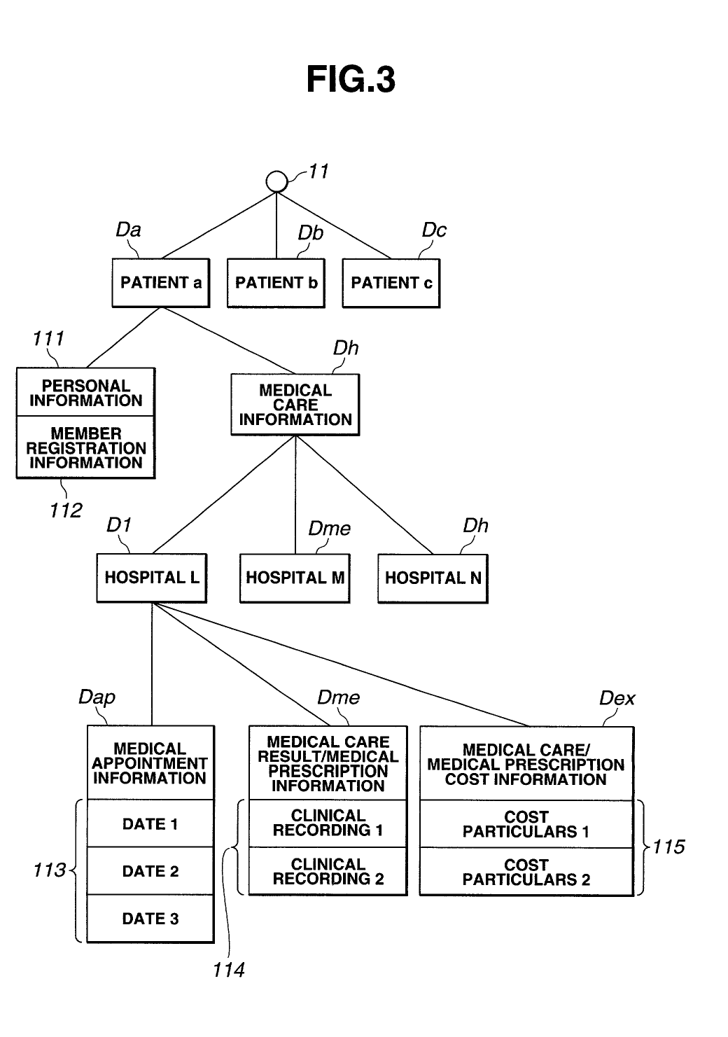

As shown in FIG. 3, the patient information data base 11 houses information of registered patients a, b and c with a directory construction. In other words, patient directories Da, Db and Dc for every patients a, b and c are generated at a top and personal information of respective patients are stored in the area of these patient directories Da, Db and Dc. Since constructions of respective patient directories Da, Db and Dc are identical, the following explanation is given only to a directory construction of the patient a, as a representative of the patient directories Da, Db and Dc.

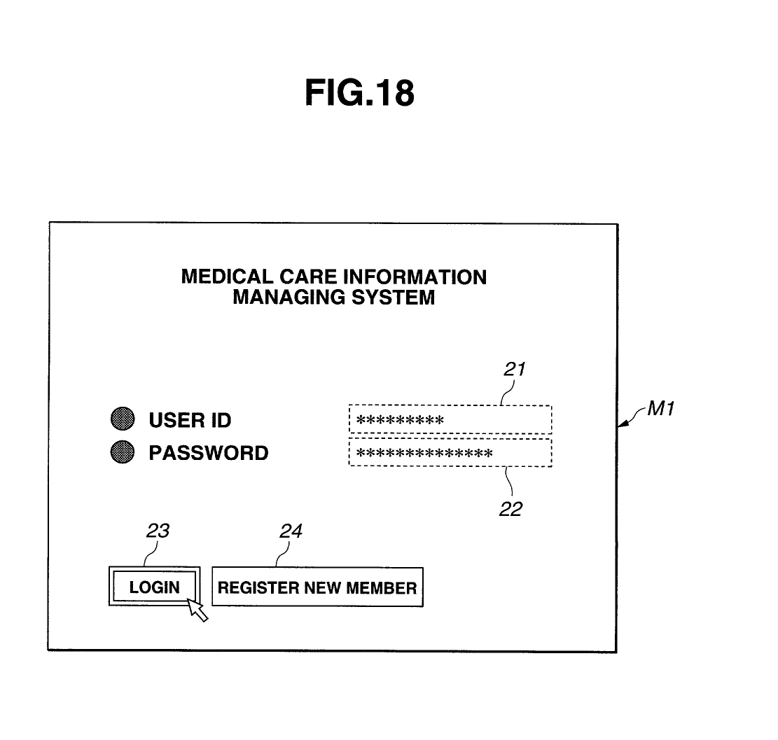

The patient directory Da houses a personal information file 111 and a member registration information file 112 as well as a medical examination information directory Dh, which can be registered by the hospital side. The personal information file 111 includes data such as USER ID and PASSWORD (see FIG. 18) or the like of the patient a issued by the medical care information managing apparatus 2 side, which are necessary for a manager side to specify a patient. The member registration information file 112 can be used between the specified hospitals as a copy of a health insurance policy.

In the medical examination information directory Dh, hospital directories Dl, Dm and Dn of the hospitals, with which the patient a makes an appointment or in which the patient a has taken a medical examination, are generated. In the areas of respective hospital directories Dl, Dm and Dn, a medical care appointment information directory Dap, a medical care result/a medical prescription information directory Dme and a medical care/a medical prescription cost information directory Dex are generated.

In the medical care appointment information directory Dap, an appointment date recording file 113 is stored to record the date data (date 1, date 2, date 3 . . . ) comprising dates the patient a made an appointment for in the past. Further, in the medical care result/a medical prescription information directory Dme, a medical dare result when the patient took a medical examination in fact and a clinical recording file 114 to record a content of the medical prescription (clinical recording 1, clinical recording 2 . . . ). Further, in the medical care/a medical prescription cost information directory Dex, a cost particulars file 115 is stored to record a cost particulars (a cost particulars 1, a cost particulars 2 . . . ) when the patient took a medical examination.

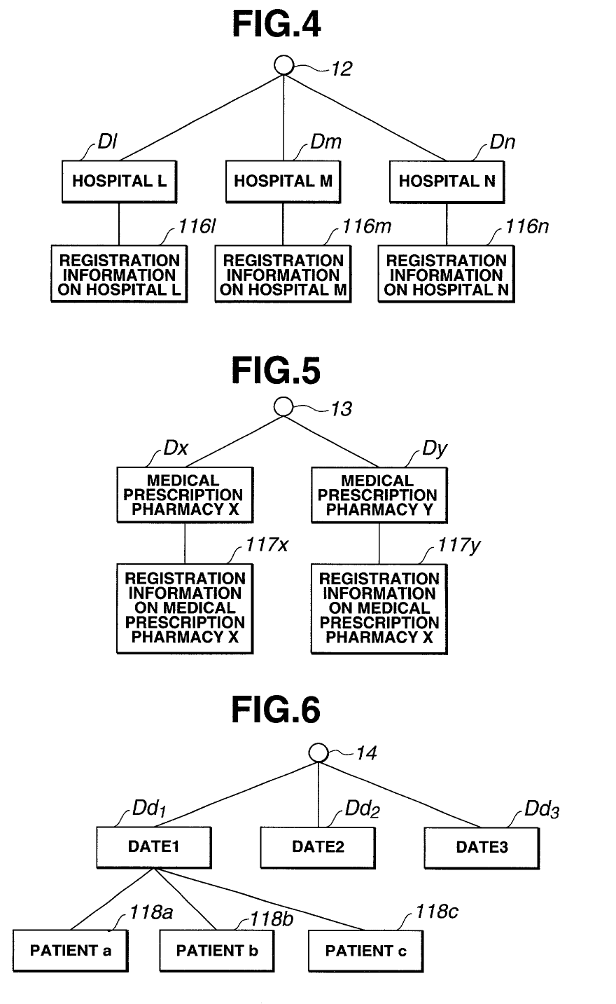

As shown in FIG. 4, in the hospital information data base 12, the hospital directories Dl, Dm and Dn of the registered and specified hospitals L, M and N are generated. In the areas of respective hospital directories Dl, Dm and Dn, registration information files 116l, 116m and 116n in which specific information on the hospitals L, M and N such as hospital locations and medical subjects or the like, which are registered by respective hospitals L, M and N, are registered are generated. These registration information files 116l, 116m and 116n are made by respective hospitals. For example, the registration information files 116l, 116m and 116n are capable of registering data such as data indicating a hospital location, a telephone number, a medical subject, a medical examination time, a map from the nearest station to the hospital and a statistical table of the rush hour conditions within the medical examination time of a day or the like.

Registering of a statistical table of the rush hour conditions allows the patients to refer to this table when deciding a time when they come to the hospital. In this case, average values during a predetermined period may be registered in the table and the registered rush hour conditions may be renewed almost as soon as the situation is changed by regularly accessing from the hospital side to the hospital information data base 12.

Further, in these registration information files 116l, 116m and 116n, it is possible to register, in advance, the cost, for example, the cost for a cosmetic surgery or the like, which is likely to be unclear. As a result of referring to this registration, the patient can decide that he/she will or will not take a surgery or a medical examination which the patient gave up because of the unclear cost. Further, hospital information besides the above items, for example, a hospital accommodation, conditions of equipment, doctors' specialties, a profile of a member association or the like, visiting reports of patients and evaluations of a hospital may be registered. In place of registration of reports and evaluations of a hospital from patients, the manager side of the medical care information managing apparatus 2 may collect information to register early detection rates of cancer or the like in each hospital. Further, allowing public sites showing the map around hospital and transportations' sites including the nearest station to link with the hospital information enables the hospital to provide information on a specific location of the hospital and transportation means diagram to patients who will visit the hospital.

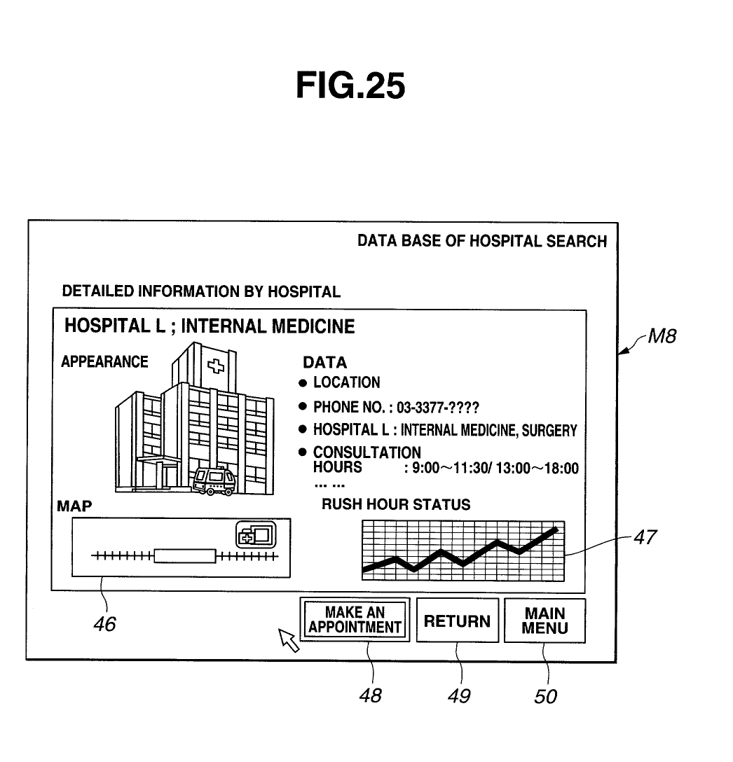

Further, as shown in FIG. 25, the registration information files 116l, 116m and 116n stored in the hospital information data base 12 is capable of indicating the content of the information on a monitor of respective patient side terminal by accessing the files.

Further, as shown in FIG. 5, in the medical prescription pharmacy information data base 13, respective medical prescription pharmacy directories Dx, Dy of registered and specified medical prescription pharmacies X and Y are generated. In the areas of respective medical prescription pharmacy directories Dx, Dy, a location of a medical prescription pharmacy and registration information files 117x and 117y for registering a telephone number or the like, which are registered by the respective medical prescription pharmacies X and Y, are stored.

Further, storing means L2, M2 and N2 of the hospital side terminals L1, M1 and N1, which are installed in respective hospitals L, M and N, are provided with appointment status data bases 14 to indicate an appointment statues of a medical examination. As shown in FIG. 6, in respective appointment status data bases 14, for example, appointed date directories Dd1, Dd2, Dd3 . . . are generated by the date. Personal information files 118a, 118b and 118c of patients a, b and c, who made an appointment, are registered in respective appointed date directories Dd1, Dd2, Dd3.

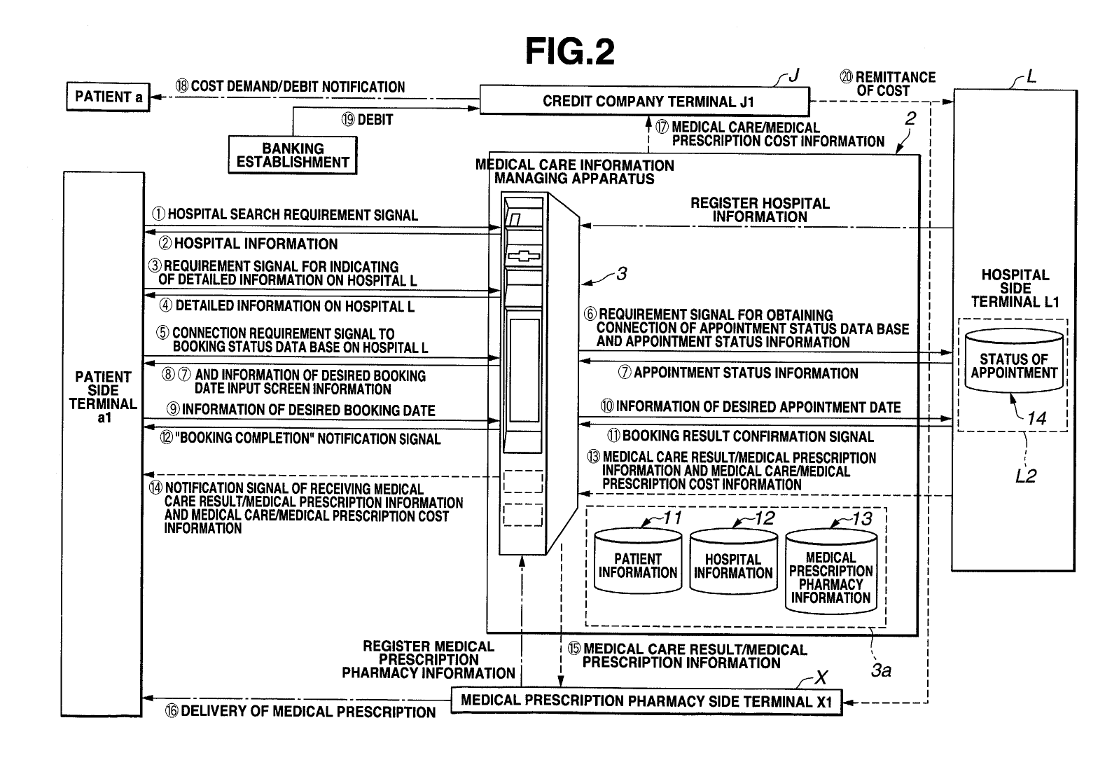

Next, with reference to a typical view of FIG. 2, a flow of a medical care information managing system is schematically explained below. In the hospital information data base 12 and the medical prescription pharmacy information database 13, which are installed in storing means 3a of the host computer 3 in the medical care information managing apparatus 2, the hospital information and the medical prescription pharmacy information are registered in advance, which are registered by respective hospital sides and respective medical prescription pharmacies sides.

To begin with, when the patient a searches a hospital, the patient side terminal a1 transmits a hospital search requirement signal to the host computer 3 of the medical care information managing apparatus 2 ((1)). For the hospital search requirement, one or a plurality of key words among a hospital name, a department where a patient intends to consult and a hospital location or the like are inputted so that these inputted information is combined and transmitted as a hospital search requirement signal.

The host computer 3 receives the hospital search requirement signal transmitted from the patient side terminal al to search the hospital information data base 12 and check whether there is a hospital corresponding to the hospital search requirement such as a key word or the like. Then, the host computer 3 transmits a list information of a hospital hit by the key word or the like to the patient side terminal a1 as a search result list information ((2)).

The patient a confirms the search result list indicated by the monitor or the like to select a hospital corresponding to the patient's desired condition, for example, the nearest hospital from the patient's house. In this case, if the patient a selects the hospital L, for example, the patient side terminal al transmits a requirement signal for indicating of detailed information on the hospital L to the host computer 3 ((3)).

Then, the host computer 3 reads the detailed information on the hospital L stored in the hospital information data base 12 to transmit the detailed information on the hospital L to the patient side terminal a1 ((4)).

The patient a checks the content of the detailed information on the hospital L indicated on the patient side terminal a1. If the patient wants to make an appointment for a medical examination at the hospital L, the patient side terminal al transmits a connection requirement signal to the appointment status data base of the hospital L to the host computer 3 ((5)).

The host computer 3 transmits a requirement signal for obtaining connection of an appointment status data base 4 and the appointment status information to the hospital side terminal L1, which is installed in the hospital L, based on the connection requirement signal from the patient side terminal a1 ((6)).

The hospital side terminal L1 receives a requirement signal from the host computer 3 to read the appointment status information stored in the appointment status data base 4 in the storing means L2. Then, the storing means L2 transmits the appointment status information to the host computer 3 ((7)). The host computer 3 transmits the appointment status information and the information of desired appointment date input screen, which are transmitted from the hospital side terminal L1, to the patient side terminal a1 ((8)).

The patient a checks the appointment status of his/her desired date in the image showing the appointment status, which is indicated on the patient side terminal a1. If the desired date is available, the patient a inputs the desired date in the desired appointment date input screen, indicated on the patient side terminal a1 and transmits the hospital search requirement signal include of information on the desired appointment date to the host computer 3 ((9)).

The host computer 3 compares the information on the desired appointment date transmitted from the patient side terminal a1 with the appointment status information transmitted from the hospital side terminal L1 to judge whether the appointment is available or not. If the appointment is available, the host computer 3 transmits the information on the desired appointment date to the hospital side terminal L1 ((10)).

The hospital side terminal L1 confirms the appointment of the patient a and registers the appointment of the patient a in the appointment status data base. Then, the hospital side terminal L1 transmits an appointment result confirmation signal to the host computer 3 ((11)).

The host computer 3 receives the appointment result confirmation signal from the hospital side terminal L1 to transmit “appointment completion” notification signal to the patient side terminal a1 ((12)). As a result, the appointment for the medical examination of the patient a has been completed.

Then, the patient a visits the hospital L on the appointed date and has a medical examination. After that, the patient comes home without paying the cost.

On the other hand, the hospital L, which completed the medical examination of the patient a, transmits a medical examination data to the host computer 3 via the hospital side terminal L1 ((13)). The hospital L transmits a medical examination data composed of a medical care result information in which a diagnosis for the patient is specified, a medical prescription information in which the medical prescription is specified, a medical care and medical prescription cost information, in which the medical care cost and the medical prescription cost are specified.

The host computer 3 stores the medical care data of the patient a transmitted from the hospital side terminal L1 in the patient information data base 11 to transmit a receiving notification signal to notify receiving of a medical care data to the patient side terminal a1 ((14)). The patient a opens a medical care data stored in the patient information data base 11 on the basis of the above receiving notification signal transmitted to the patient side terminal a1, so that the patient a can browse a medical care cost, the content of a medical result and a location of the medical prescription pharmacy, where the patient a took a medicine.

On the other hand, the host computer 3 searches the medical prescription pharmacy information data base 13 on the base of the address of the patient a stored in the patient information data base 11 to find the nearest specified medical prescription pharmacy from the patient a's home. In the other case, it is possible to designate the patient's desired medical prescription pharmacy among the medical prescription pharmacies registered in the medical prescription pharmacy information data base 13. In this case, it is necessary to register in advance the patient's desired medical prescription pharmacy in the patient information data base 11 of the patient a.

Then, when this medical prescription pharmacy is X, for example, the host computer 3 transmits the address, the information on the medical care result and the medical prescription of the patient a to the medical prescription pharmacy side terminal X1, which is arranged in the medical prescription pharmacy X based on the medical care data ((15)).

The medical prescription pharmacy X prepares a medicine for the patient a depending on the medical prescription indicated in the medical prescription pharmacy side terminal X1. Then, the medical prescription pharmacy X delivers the medicine by a medical prescription delivery to the patient a's home ((16)). Alternatively, the patient a directly visits the medical prescription pharmacy X to get the medicine.

Further, the host computer 3 transmits the medical care/a medical prescription cost information, which specify the medical care cost and the medical prescription cost, to a terminal J1 of a credit company J, with which the patient a contracts ((17)). This credit company J is designated by the patient a and it is registered in the patient information data base 11 of the patient a in advance.

The credit company J sends a bill and a debit notification, which are printed out from a credit company terminal J, by mail to the patient a's home ((18)). Then, the credit company J checks off the medical care cost and the medical prescription cost from a banking establishment of the patient a ((19)).

On the other hand, the credit company J makes a remittance of the medical care cost and the medical prescription cost to the hospital L and the medical prescription pharmacy X, respectively ((20)).

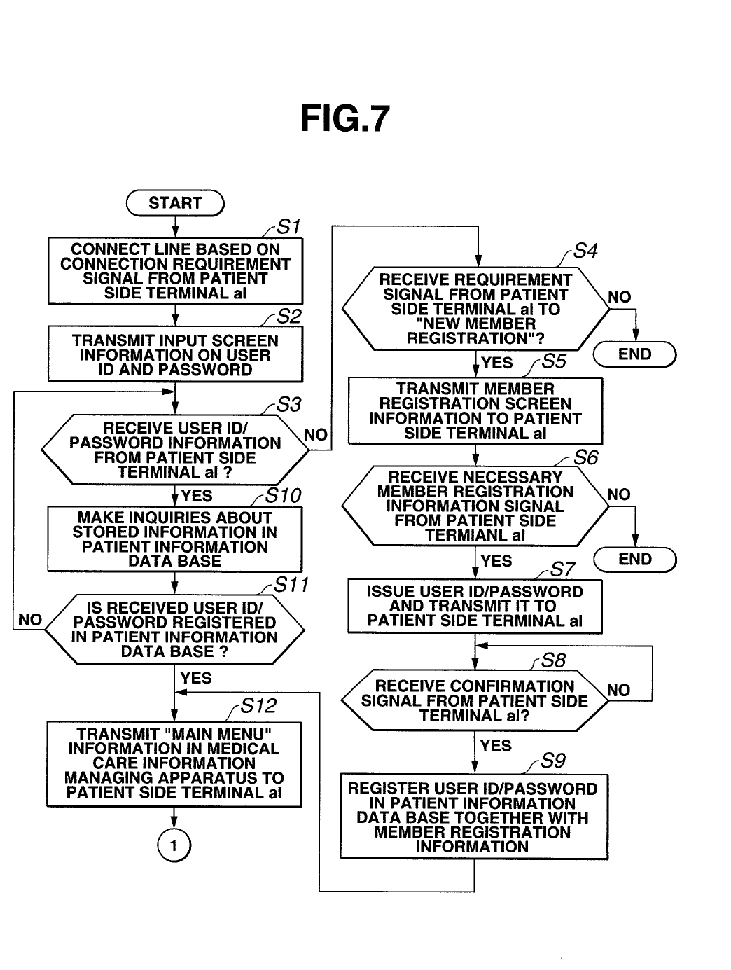

Next, with reference to FIGS. 7-31, a specific flow of a procedure that a patient and a hospital have respectively access to the host computer 3 of the medical care information managing apparatus 2, is explained below.

In the mean time, access authorities to the host computer 3 are given to the three persons, i.e., a patient, a hospital and a system administrator, and USER ID is registered separately for USER ID for a patient, USER ID for a hospital and USER ID for a system administrator. The access authorities from the patient and the hospital to respective data bases 11-14 are shown in a table 1.

TABLE 1

| | patient information data | | | appointment |
|---|---|---|---|---|
| | base | | hospital | status |
| | personal | medical care | information | information |
| | information | information | data base on | data base on |
| | on patient a | on patient a | hospital L | hospital L |
| USER ID for | ⊚ | Δ | Δ | Δ |
| patient a | | | | |
| USER ID for | X | X | Δ | Δ |
| patient c | | | | |
| USER ID for | Δ | ◯ | ⊚ | ⊚ |
| hospital L | | | | |
| USER ID for | X | X | Δ | X |
| hospital N | | | | |

In the above table 1 with the information registered by an individual, the mark represents “inspection, edition, deletion, registration available”; the mark ∘ represents “inspection, addition, registration available”; the mark Δ represents “inspection available”; the mark × represents “access unavailable”.

However, when it is assumed that the patient a makes an appointment for the medical care at the hospital L and neither the patient C nor the hospital N is related to the patient a and the hospital L, the medical care information on the patient who had the medical care in the hospital L and the appointment status data base of the hospital L are to be managed at the hospital L's door. Further, in the case when the hospital L introduces the patient a to the hospital N, it becomes possible for the hospital N to browse the medical care information on the patient a by the hospital L informing the USER ID of the patient a to the hospital N. The USER ID for the hospital may not be limited for every hospital and the information of the USER ID may be set by classifying information on every department in a hospital. By using these access authorities, the transmission of a specific medical care result can be limited in accordance with the transmitters' authorized status.

With respect “addition” represented by the mark ∘, the case when the hospital L performs the medical care to the patient a again is particularly considered. In the case when a patient visits not for the first time, it is not necessary to register a new “medical care result/medical prescription information” anew in the patient information data base 11 but the record thereof is recorded in the past “medical care result/medical prescription information” as a postscript. Further, in this case, the hospital may select whether they register the record as a new “medical care result/medical prescription information” or register it as a postscript to the past “medical care result/medical prescription information”.

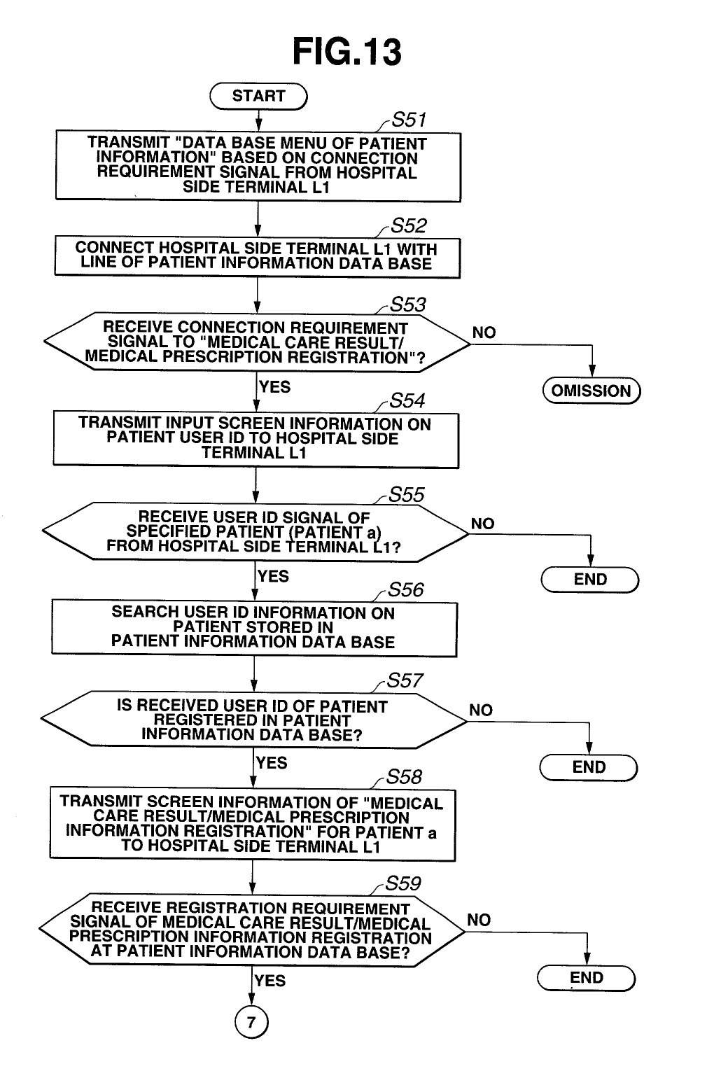

With respect to flowcharts shown in FIGS. 7-12, a procedure that a patient has access to a host computer 3 is explained below. Then, a procedure that a hospital has access to a host computer is explained below with respect to flow charts shown in FIGS. 13-16.

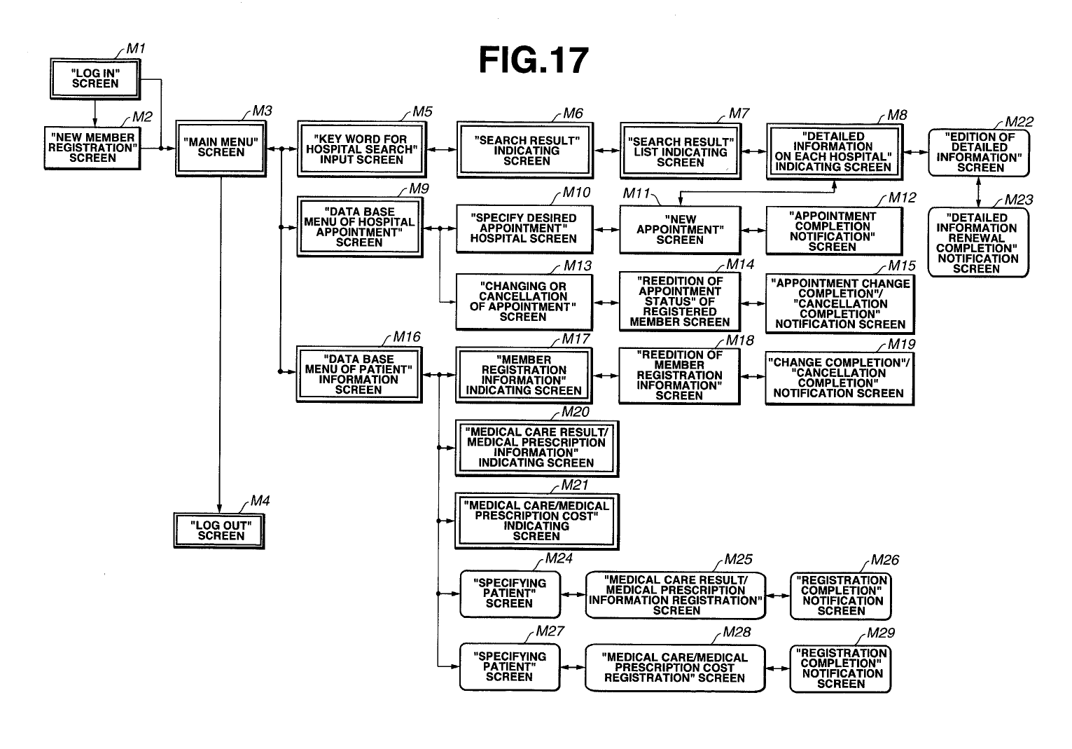

At the same time, a monitor image indicated in respective terminals is explained with reference to a hierarchical structure of an image shown in FIG. 17. Here, a single line frame is a dedicated screen that a specified patient only can open, a double line frame is a common screen that the both of a patient and a hospital can open and a frame with round corners is a dedicated screen a specified hospital only can open. Further, FIGS. 18-31 illustrate typical examples of an image to be indicated on a monitor.

At first, a procedure that a patient makes an appointment for a medical care at a hospital is explained. When the patient intends to use a medical care information managing system, at first, it is required to perform a registration procedure to a medical care information managing apparatus 2. On the assumption that a patient is a patient a, the case that the patient a makes an appointment for the medical care at the hospital is explained below.

The patient a transmits a connection requirement signal to the host computer 3, which is installed in the medical care information managing apparatus 2, from a patient side terminal al via a communication network 4 such as the Internet or the like. Then, a medical care appointment routine is started up shown in FIGS. 7-12, so that the patient side terminal a1 is connected to the line of the host computer 3 based on the connection requirement signal from the patient side terminal a1 in step S1.

Then, in step S2, the host computer 3 transmits a LOG IN screen information to the patient side terminal a1 and in step S3, the host computer 3 expects to receive a requirement signal to be transmitted from the patient side terminal a1.

A “LOG IN” screen M1 as an initial screen is indicated on the monitor of the patient side terminal a1, which receives the LOG IN screen information from the host computer 3. As shown in FIG. 18, the “LOG IN” screen M1 indicates a window 21 into which USER ID is to be inputted, a window 22 into which PASSWORD is to be inputted, a “LOG IN” button 23 and a “new member registration” button 24.

Then, the patient a moves a pointer to the new member registration button 24 by the operation of a mouse or the like to turn on the button 24. As a result, the requirement signal to require the new member registration is transmitted to the host computer 3.

The host computer 3 judges classes of the received requirement signal in steps S3 and S4. Since this requirement signal comprises a requirement signal of “new member registration”, a program proceeds from step S4 to step S5. Further, when the patient a pushes, for example, “Esc” key on a key board with “LOG IN” screen M1 indicated, this routine is ended and the line between the patient side terminal a1 and the host computer 3 is shut out.

When the program proceeds to step S5, the host computer 3 transmits a mender registration screen information to the patient side terminal a1 and expects to receive a member registration information signal to be transmitted from the patient side terminal a1 in step S6.

On the other hand, if the patient side terminal a1 receives the member registration screen information transmitted from the host computer 3, the “new member registration” screen M2 is indicated on the monitor of the patient side terminal a1 as shown in FIG. 17. For example, as shown in FIGS, 19 and 20, the “new member registration” screen M2 is composed of two layers of the “new member registration (1)” screen M2′ for inputting personal information and the “new member registration (2)” screen M2″ for inputting a contents of the contracted insurance. On the “new member registration (1)” screen M2′, which is indicated at first, a personal information input window 25 for inputting the personal information such as the name, sex, birth of date, address, telephone number and E mail address or the like of the patient a is indicated as well as a “next” button 26 to move to a lower layer and a “cancel” button 27 are indicated.

If the patient a inputs a required information to respective windows indicated on the “new member registration (1)” screen M2′ and turns on the “next” button 26, an insurance information input window 28 for inputting the contents of the contracted insurance is indicated, which included the “new member registration (2)” screen M2″ in the lower layer is indicated. On the “new member registration (2)” screen M2″, kinds of health insurance, an assured person code and number, a name of assured person, a relation with a member registered person, an assurer's name and an assurer's number or the like, as well as a “completion” button 29, a “return” button 30 to return to an upper layer and a “cancel” button 31 are indicated.

The patient a inputs a required information in the personal information input window 25 indicated on the “new member registration (1)” screen M2′ and further inputs a required information in the insurance information input window 28 indicated on the “new member registration (2)” screen M2″. Then, the patient a turns on the “completion” button 29 to transmit these inputted contents to the host computer 3 as a member registration information signal.

When the host computer 3 confirms receiving of the member registration information signal in step S6, the program proceeds to step S7. Upon turning on the “cancel “button 27 or 31 under the condition that the “new member registration (1)” screen M2′ or the “new member registration (2)” screen M2″ is indicated, the routine is ended and the line between the patient a1 and the host computer 3 is shut out.

Further, proceeding to step S7, the host computer 3 issues USER ID and PASSWORD for the patient a and transmits an issue notification signal to the patient side terminal a1 to proceed to step S8 and wait for a confirmation signal to be transmitted from the patient side terminal a1.

On the other hand, receiving the issue notification signal in the patient side terminal a1, the monitor indicates USER ID and PASSWORD for a patient as well as indicates a window for inputting repeatedly the USER ID and the PASSWORD for a patient (not illustrated) on its lower layer. As the patient a inputs to this window repeatedly the USER ID and the PASSWORD for a patient and turns on a confirmation button (not illustrated) indicated on the screen, a confirmation signal is transmitted to the host computer 3 to notify the confirmation of the USER ID and the PASSWORD for a patient. In this case, the confirmation signal may be transmitted only by turning on the confirmation button without repeatedly inputting the USER ID and the PASSWORD for a patient. Alternatively, the USER ID and the PASSWORD for a patient may be printed out from the patient side terminal a1.

When the host computer 3 receives the confirmation signal transmitted from the patient side terminal a1, the program proceeds from step S8 to step S9. Turning on the cancel button indicated on the screen, on which the USER ID and the PASSWORD for a patient are indicated, the routine is ended and the line between the patient side terminal a1 and the host computer 3 is shut out.

Proceeding to step S9, the host computer 3 generates a patient directory Da of the patient a in the patient information data base 11 and further generates a personal information file 111 and a member registration information file 112 in the patient directory Da. The host computer 3 registers the USER ID and the PASSWORD for the patient a in the personal information file 111 and further registers the member registration information of the patient a in the member registration information file 112 to proceed to step S12.

Through the above procedures, the registration of the patient a has been completed and the program shifts from step S12 to a normal medical care appointment procedure. Therefore, the normal medical care appointment procedure will be explained below.

In the normal medical care appointment procedure, the patient side terminal a1 has access to the host computer 3 and the LOG IN screen information transmitted in step S2 is indicated on the patient side terminal a1. Then, in step S3, the host computer 3 waits for receiving the USER ID and the PASSWORD for the patient to be transmitted from the patient side terminal al as same as described above.

On the other hand, the “LOG IN” screen M1 is indicated on the monitor of the patient side terminal a1. The patient a inputs a predetermined USER ID and PASSWORD in the window 21 into which USER ID is to be inputted, which is indicated on the “LOG IN” screen M1 and a window 22 into which PASSWORD is to be inputted to turn on the “LOG IN” button 23.

Then, the USER ID/PASSWORD information for the patient signal is transmitted from the patient side terminal a1 to the host computer 3. The host computer 3 receives this information signal. The program proceeds from step S3 to step S10 to compare the received information signal with the stored information in the patient information data base 11 of the host computer 3.

After that, the program proceeds to step S11 to judge whether the received USER ID/PASSWORD information for the patient is registered in the patient information data base 11 or not. If it is not registered, the program returns to step S3 to be on standby until a new USER ID/PASSWORD information for the patient is received. Further, in this case, the “LOG IN” screen M1 is kept indicated on the monitor of the patient side terminal al, so that a message may be indicated on the “LOG IN” screen M1 to notify an input error.

On the other hand, if the USER ID/PASSWORD information for the patient inputted by the patient a is registered in the patient information data base 11, the program proceeds to step S12 to transmit a “main menu” screen information of the medical care information managing system.

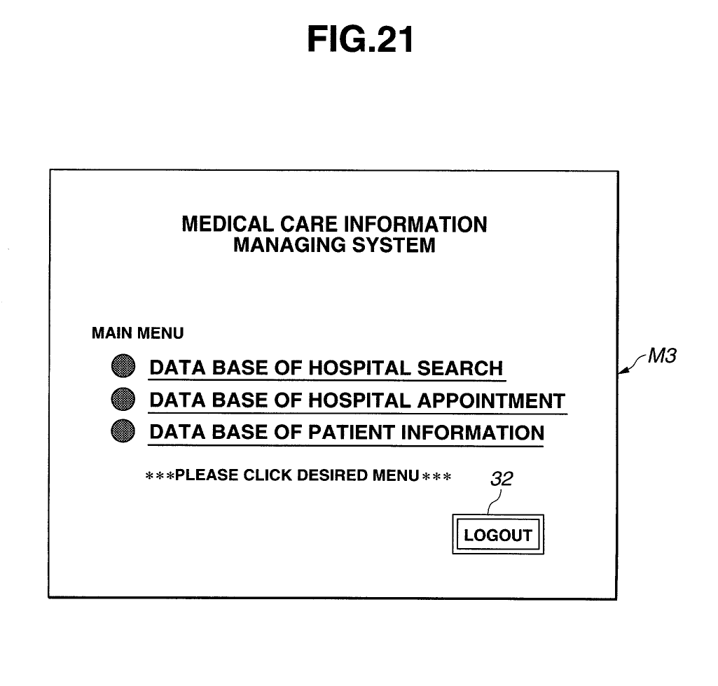

Then, a “main menu” screen M3, for example, as shown in FIG. 21, is indicated on the monitor of the patient side terminal al. On this “main menu” screen M3, selection menus composed of three items of a hospital search data base, a hospital appointment data base and a patient information data base which shift to lower layers and a “LOG OUT” button 32 are indicated. The host computer 3 expects to receive a requirement signal to indicate which menu the patient a selects in steps S13-S15.

Here, the hospital search data base comprises a menu such that the patient a searches a desired hospital by inputting the key word. The hospital appointment data base comprises a menu such that the patient a has a direct access to the terminal of the desired hospital when the desired hospital is decided in advance. The patient information data base comprises a menu such that the patient a has access to the patient information data base 11 of the host computer 3 to browse one's own information such as the past medical examination record registered in the patient information data base 11.

If the patient a turns on the “LOG OUT” button 32, the LOG OUT screen information is transmitted from the host computer 3 to the patient side terminal a1 and the “LOG OUT” screen M4 is indicated on the monitor of the patient side terminal a1 (see FIG. 17). Then, the line between the patient side terminal a1 and the host computer 3 is shut out.

The patient a shifts a pointer to the indicated location of the above “hospital search data base” and turns on the point to select, for example, the hospital search data base from the menus indicated on the monitor of the patient side terminal a1. Then, the patient side terminal a1 transmits a requirement signal to require “hospital search data base” to the host computer 3. A flow for selecting the hospital booking data base and the patient information data base are explained later.

When the host computer 3 receives the requirement signal to require “hospital search data base” transmitted from the patient side terminal a1, the program proceeds from step S13 to step S16 and the host computer 3 is connected to the hospital information data base 12. In the following step S17, the host computer 3 transmits a “hospital search key word” input screen information to the patient side terminal a1. The program proceeds to step S18 and the host computer 3 expects to receive a requirement signal to be transmitted from the patient side terminal a1.

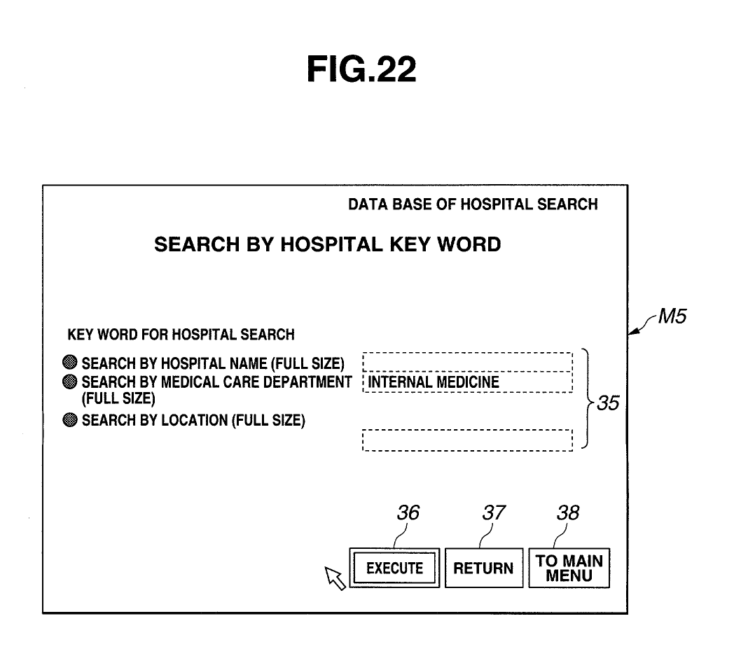

Then, a “hospital search key word “input screen M5, as shown in FIG. 22, is indicated on the patient side terminal a1. On this “hospital search key word ” input screen M5, as searched items, a window 35 and an “execution” button 36, a “return” button 37 and “main menu” button 38 are indicated. The window 35 is inputted by three items including search for a hospital name, search for a medical department and search for a hospital location.

After the patient a1 selects at least more than one item from these input items to input the search key and turns on the “execution” button 36, the search key word and a requirement signal for search are transmitted to the host computer 3.

The host computer 3 receives them, the program proceeds to step S19. In step S19, the host computer 3 searches the hospital information data base 12 and checks whether a hospital information corresponding to the search key word is registered or not in step S20.

When there is no registered hospital information corresponding to the search key word, the program returns to step S17 to transmit the input screen information of “hospital search key word” to the patient side terminal a1 again. On the other hand, if there is registered hospital information corresponding to the search key word, the program proceeds to step S21 and the host computer 3 transmits a list information on search result to the patient side terminal a1 to wait for an indication requirement signal from the patient side terminal al.

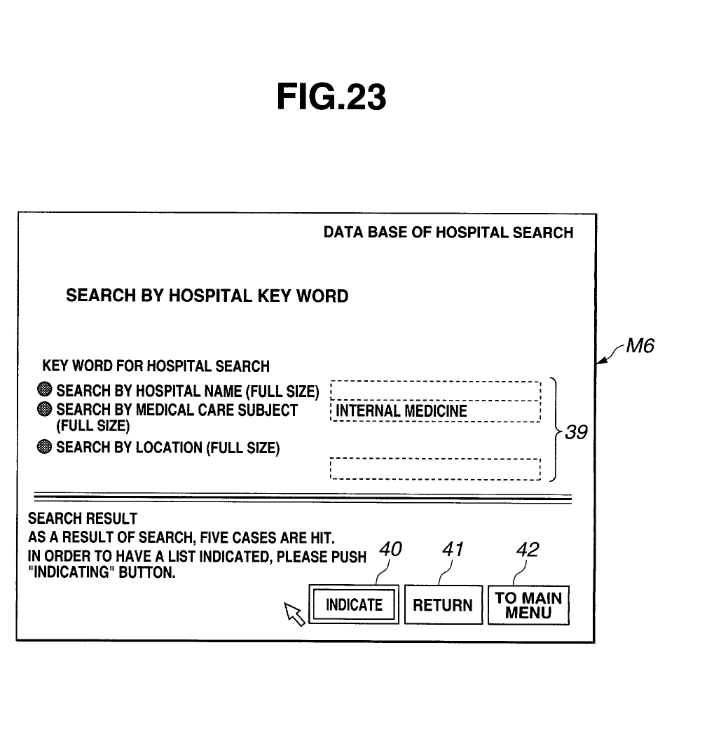

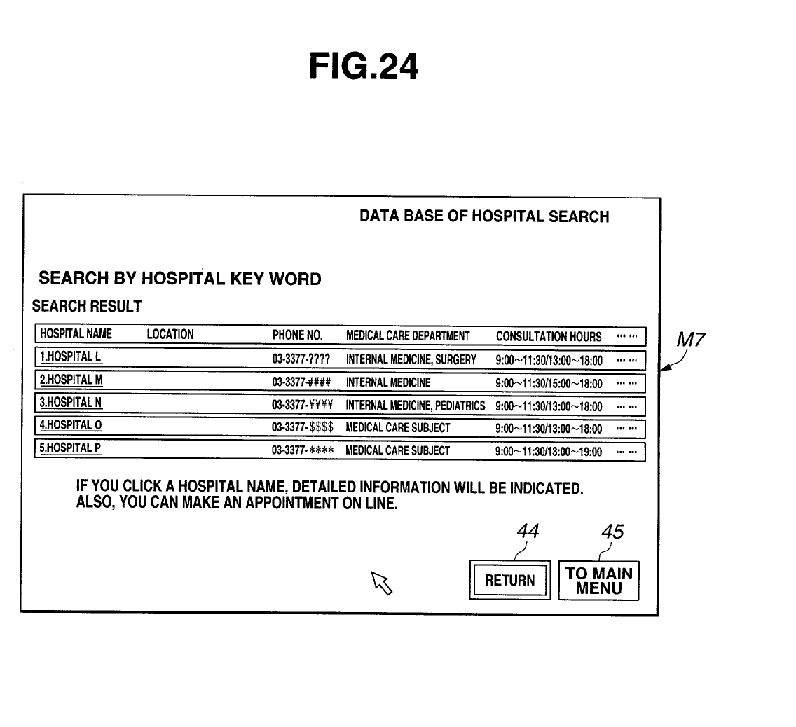

When the list information on search result is transmitted to the patient side terminal a1, the monitor of the patient side terminal a1 indicates a “search result” indicating screen M6 in FIG. 23 and the monitor of the patient side terminal a1 becomes capable of indicating a “search result” list indicating screen M7 in FIG. 24.

On this “search result” list indicating screen M6, a window 39 indicated the key word inputted by the patient a, an “indicate” button 40, a “return” button 41 and a “to main menu” button 42 are indicated and the number of hit by the search is also indicated.

When there is no registered hospital information corresponding to the search key word, it becomes possible to omit a judging routine in step S20 by having the number of hit as 0 indicated. In this case, the patient a turns on the “return” button 41 and indicates the “hospital search key word” input screen M5 and inputs a key word for searching a hospital again.

If the patient a turns on the “indicate” button 40, the 'search result” list indicating screen M7, which is located below thereof, is indicated on the monitor. On this “search result” list indicating screen M7, a name, a location, a telephone number, a medical department and a medical care time of a hit hospital are indicated as well as the “return” button 44 and the “to main menu” button 45 are indicated.

The patient a refers to a hospital list and specifies the desired hospital, the patient a shifts a pointer to the name of the specified hospital to turn it on. Then, an indication requirement signal for the detailed information on the specified hospital is outputted to the host computer 3.

When the host computer 3 receives the indication requirement signal for the detailed information on the specified hospital, the program proceeds to step S23. Then, the host computer 3 transmits the detailed information on the specified hospital, which is stored in the hospital information data base 12, to the patient side terminal a1 to proceeded to step S24 to wait for transmitting of the connection requirement signal from the patient side terminal a1.

For example, in the case that the patient a designates the hospital L as a specified hospital, the host computer 3 transmits the detailed information on the hospital L to the patient side terminal a1. The case that the patient a specified a hospital L and makes an appointment for a medical care at the hospital L is explained with an example below.

When the patient side terminal a1 receives the detailed information on the specified hospital, the monitor indicates a “detailed information on each hospital” indicating screen M8. For example, if the patient a requires indication of the detailed information on the hospital L as shown in FIG. 25, the “detailed information on each hospital” indicating screen M8 indicates the information on the hospital L, an “appointment” button 48, a “return” button 49 and a “to main menu” button 50. The information on the hospital L includes a location, a telephone number, a medical department, a medical care time, a map 46 from the nearest station or a graph 47 showing an average rush hour condition during a consultation hour of the hospital L.

The patient a confirms the above indication to turn on the “appointment” button 48, the connection requirement signal for the appointment status data base 14 of the hospital L is transmitted to the host computer 3. The host computer 3 receives the connection requirement signal and the program proceeds to step S27.

On the other hand, if a hospital at which the patient a makes an appointment for the medical examination is specified, it is necessary to search the hospital. Therefore, the host computer 3 shifts a pointer to a location to indicate the “hospital appointment data base”, which is indicated on the “main menu” screen M3 (see FIG. 21) and turns it on.

Then, a requirement signal for “hospital appointment data base” is transmitted to the host computer 3, so that the host computer 3 receives the requirement signal for “hospital appointment data base”. After that, the program proceeds from step S14 to step S25 and the host computer 3 transmits a “hospital appointment data base menu” screen information to the patient terminal a1.

This “hospital appointment data base menu” screen information has a layer configuration. In the lower layer of the “hospital appointment data base menu” screen information, a “specify desired appointment hospital” screen information and a “changing or cancellation of appointment” screen information are arranged.

The patient side terminal a1 receives the “hospital appointment data base menu” screen information. Further, a “hospital appointment data base menu” screen M9 is indicated on the monitor of the patient side terminal a1 (see FIG. 17). Two items including a “specify desired appointment hospital” item and a “changing or cancellation of appointment” item are indicated on the “hospital appointment data base menu” screen M9 to shift to the lower layers. The patient a selects any one of these two items.

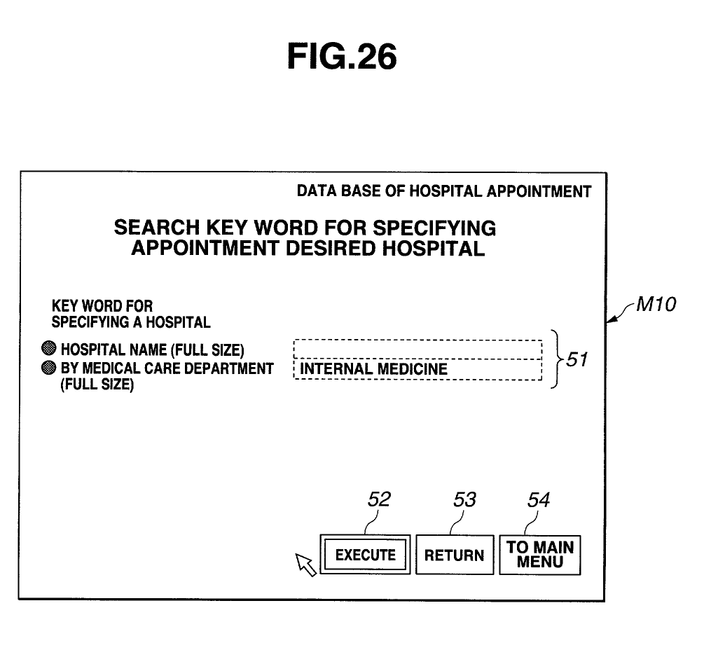

If the patient a selects the “specify desired appointment hospital” item, a “specify desired appointment hospital” screen M10 is indicated. On this “specify desired appointment hospital” screen M10, for example, as shown in FIG. 26, a window 51 into which a hospital name and a medical subject name are to be inputted, an “execution” button 52, a “return ” button 53 and a “to main menu” button 54 are indicated.

Inputting a hospital name in which the patient a wants to have a medical care, for example, a hospital L and a medical department name in the window 51 into which a hospital name and a medical department name are to be inputted and turning on the “execution” button 52, a connection requirement signal for the appointment status data base 14 of the specified hospital L is transmitted to the host computer 3. The host computer 3 receives the connection requirement signal and jumps from step S26 to step S27.

When the program proceeds from step S24 or from step S26 to step S27, the host computer 3 connects the line to the appointment status data base 14 installed in the storing means L2 in the hospital side terminal L1, which is arranged in the hospital L. Then, the host computer 3 proceeds to step S28 to receive the appointment status information. In step S29, the host computer 3 transmits the appointment status information of the hospital L together with a desired appointment date input screen information to the patient side terminal a1. Further, at the same time, the host computer 3 temporarily stores a copy of this appointment status information in the storing means in the host computer 3.

Proceeding to step S30, the host computer 3 waits for transmission of the desired appointment date information from the patient terminal a1.

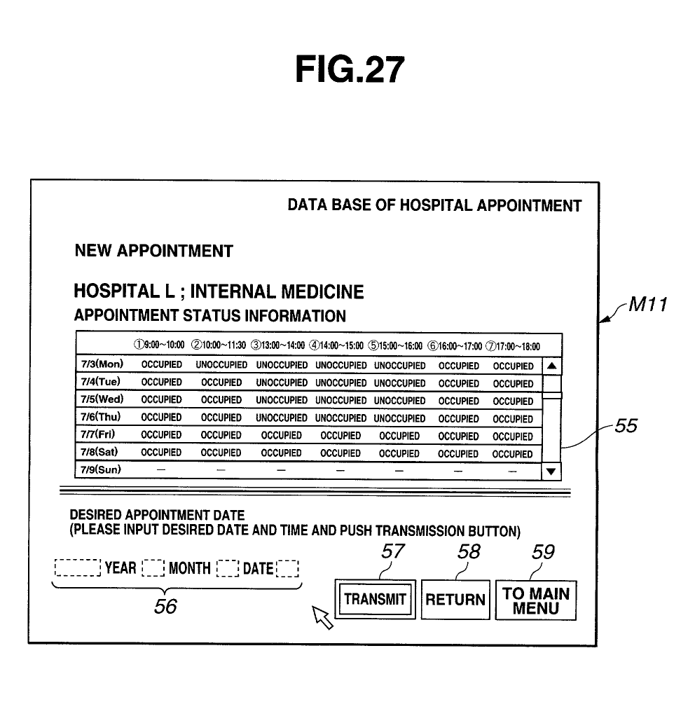

When the patient terminal a1 receives the desired appointment date input screen information and the appointment status of the hospital L, the monitor of the patient terminal al indicates a “new appointment” screen M11. As shown in FIG. 27, this “new appointment” screen M11 indicates a window 55 and indicates a window 56, a “transmit” button 57, a “return” button 58 and a “to main menu” button 59 in the lower layer. The window 55 shows the appointment status at the date when the hospital accepts appointment. The appointment date is inputted in the window 56, which is in the lower layer of the window 55.

The patient a refers to the window 55 to show the appointment status and inputs the desired appointment date (for example, July 6, 13:00-14:00) in the desired appointment date input window 56 and turns on the “transmit” button 57, the desired appointment date information is transmitted to the host computer 3 and the host computer 3 receives it. Then, the host computer 3 proceeds to step S31 to compare the received desired appointment date with the appointment status information of the hospital L, which is temporally stored. After that, the host computer 3 proceeds to step S32 to judge the appointment is available at the desired appointment date or not. If the desired appointment day is occupied, the host computer 3 returns to step S30 and expects to receive a new desired appointment date information to be transmitted from the patient side terminal a1.

If the desired appointment day is unoccupied, the host computer 3 proceeds to step S33 and transmits the desired appointment date information to the hospital side terminal L1 of the hospital L. In step S34, the host computer 3 expects to receive an appointment result confirmation signal to be transmitted from the hospital side terminal L1.

The hospital side terminal L1 based on the desired appointment date information transmitted from the host computer 3 registers the appointment date of the patient a in the personal information file 118a, which is generated in corresponding appointment date directories Dd1, Dd2, Dd3 . . . of the appointment status data base 14. Alternatively, if the patient a is a new patient, the hospital side terminal L1 newly generates the personal information file 118a to register the appointment date in this directory. Then, the hospital side terminal L1 transmits the booking result confirmation signal to the host computer 3.

If the host computer 3 receives the appointment result confirmation signal, it proceeds to step S35 to shut out the connection to the appointment status data base 14 of the hospital side terminal L1. Then, the host computer 3 proceeds to step S36 to check whether the patient directory Da of the patient a is generated in the patient information data base 11. If the patient directory Da is already generated, the host computer 3 jumps to step S38. If the patient directory Da is not generated, it branches to step S37.

In step S37, the host computer 3 generates the patient directory Da of the patient a in the appointment status data base 14 to generate the personal information file 111 to register the USER ID and the PASSWORD of the patient a, the member registration information file 112 of the patient a and the medical examination information directory Dh in this directory. Further, the host computer 3 generates the medical care appointment information directory Dap, the medical care result/medical prescription information directory Dme and the medical care/a medical prescription cost information directory Dex in the area of hospital examination information directory Dh (see FIG. 3) to proceed to step S38.

In step S38, the host computer 3 registers the appointment date in the appointment date recording file 113 which is stored in the medical care appointment information directory Dap of the patient directory Da, which is generated in the patient information data base 11.

Even when the patient directory is already generated in the patient information data base 11, a directory to register various medical care information may be generated in the patient directory for every appointment.

Then, the host computer 3 proceeds to step S39 to transmit a notification information on appointment completion to the patient side terminal a1 and shut out the line to connect the host computer 3 of the medical care information managing apparatus 2 to the patient side terminal a1 based on a shut out requirement signal from the patient side terminal a1. Thus, the routine is ended.

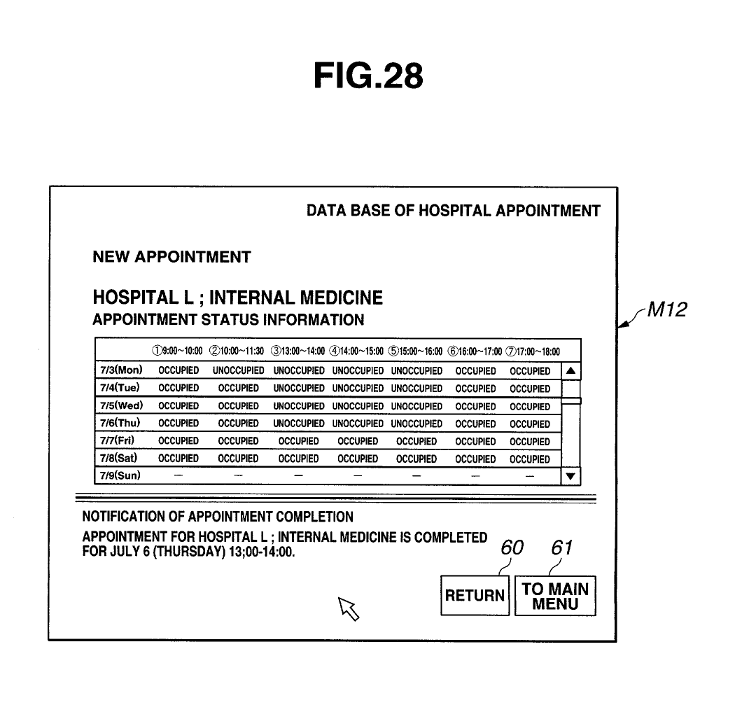

When the patient side terminal a1 receives the notification information on appointment completion from the host computer 3, the monitor of the patient side terminal a1 indicates a “appointment completion notification” screen M12. As shown in FIG. 28, on this “appointment completion notification” screen M12, a window showing the appointment is indicated and in the lower column thereof, a message to notice the appointment completion, a “return” button 60 and a “to main menu” button 61 are indicated. The patient a refers to the “appointment completion notification” screen M2. As a result, if the patient a confirms that the appointment is approved, for example, the patient a turns on the “to main menu” button 61. Then, the indication of the monitor is switched to the “main menu” screen M3. Further, turning of the “LOG OUT” button 32, the patient side terminal a1 transmits the shut out requirement signal to the host computer 3.

As a result, the indication of the monitor is switched from the “main menu” screen M3 to the “log out” screen M4. Then, the line between the patient side terminal a1 and the host computer 3 is shut out.

Next, under the condition that the “hospital appointment data base menu” screen M9 is indicated, the case is briefly explained, that the “changing or cancellation of appointment” menu is selected.

This “changing or cancellation of appointment” menu is selected in the case the medical care appointment date, that the patient a once applied for, is changed or cancelled. Selecting the “changing or cancellation of appointment” menu, a “changing or cancellation of appointment” screen M13 is indicated in the lower layer. Here, the patient a inputs an appointed hospital name and an appointed date to confirm the content by turning on the “execution” button or the like.

Then, having access to the appointment status data base 14 of the hospital side terminal of the appointed hospital, the screen is switched to a reedition of appointment status” screen M14 of the registered member. In the “reedition of appointment status” screen, a screen showing a current appointment status is indicated. Referring to this screen's indication, when changing the appointment, the patient a inputs a changed appointment date. When canceling the appointment, the patient a checks a window for cancellation to decide the content by turning on the “execution” button. As a result, the appointment status is reedited. If this reedition is accepted, a “appointment change completion”/“cancellation completion” notification screen M15 is indicated. Thus, the appointment change or the appointment cancellation is completed.

Further, under the condition that the “main menu” screen M3 is indicated on the patient side terminal a1 (see FIG. 21), if the patient a shifts a pointer to an indicating location of the “patient information data base” to turn it on, a requirement signal is transmitted from the patient side terminal a1 to the “patient information data base”. The host computer 3 receives this signal and the program proceeds from step S15 to step S40. In step S40, the host computer 3 transmits the “patient information data base” menu screen information to the patient side terminal a1. Then, the host computer 3 proceeds to step S41 to expect that a connection requirement signal is transmitted from the patient side terminal a1.

When the patient side terminal a1 receives the “patient information data base” menu screen information, the monitor of the patient side terminal a1 indicates the “patient information data base menu” screen M16. On this the “patient information data base menu” screen M16, three items including a “member registration information” item, a “medical care result/medical prescription information” item and a “medical care/medical prescription cost” item are indicated.

Further, if the patient a shifts a pointer to a location that any one of the above items is indicated to turn it on, a connection requirement signal for the patient information data base 11 is transmitted to the host computer 3.

The host computer 3 receives the connection requirement signal for the patient information data base 11 transmitted from the patient side terminal a1 to proceed to step S42. In step S42, the host computer 3 searches in the directory of the patient directory Da of the patient a, which is generated in the patient information data base 11, based on the inputted USER ID for the patient. Then, in step S43, the host computer 3 transmits the indicating screen information of the patient information corresponding to the item selected by the patient a to the patient side terminal a1.

When the patient side terminal a1 receives the patient information, the monitor of the patient side terminal a1 indicates a “member registration information” indicating screen M17, a “medical care result/medical prescription information” indicating screen M20, or a “medical care/medical prescription cost” indicating screen M21, which are selected by the patient.

Note that the “member registration information” indicating screen M17 comprises a screen to change or cancel the content, which is registered in the member registration information file 112, which is stored in the patient directory Da of the patient a in the patient information data base 11. If the patient a checks the window to change or cancel the member registration information to decide the content by turning on the “execution” button, which is indicated on the screen. Accordingly, the screen is switched to a “reedition of member registration information” screen M18 in the lower layer. When the patient a checks the content of changing or canceling the member registration information to decide the content by turning on the “confirmation” button or the like, a “change completion”/“cancellation completion” notification screen M19 is indicated. Thus, a procedure of changing the member registration information of cancellation thereof is completed.

Deciding the content by turning on a “completion” signal indicated on respective screens or the like, a shut out requirement signal is transmitted to the host computer 3. The host computer 3 receives the shut out requirement signal to proceed to step S44. Then, the host computer 3 shuts out the line between the host computer 3 of the medical care information managing apparatus 2 and the patient side terminal a1. Thus, the routine is ended.

Note that “detailed information on each hospital” indicating screen M8 indicated in FIG. 25 is capable of being updated sequentially from the hospital side terminal L1. In other words, inputting the USER ID for the hospital of the hospital L, which is registered in advance in the hospital side terminal L1, calling a “edition of detailed information” screen M22 to edit the “detailed information on each hospital” indicating screen M8 to edit the content and registering the content, the host computer 3 transmits the “detailed information renewal completion” notification screen information to indicate the “detailed information renewal completion” notification screen M23 on the monitor. Thus, the update is completed.

Next, a procedure to input the medical care result and the medical prescription information to the medical care result/a medical prescription information directory Dme, which is generated in the hospital directory D1, by having access from the hospital side terminal L1 to the patient information data base 11 is explained below.

During the medical examination of the patient a by a doctor in the hospital L or when the medical examination is finished, the doctor has access to the host computer 3 of the medical care information managing apparatus 2 in place of filling out a clinical recording to register the medical care result/medical prescription information of the patient a or the like to the patient information data base 11, which is capable of being accessed from the outside, via the communication network such as the Internet or the like. Thus, the record of registration of this medical care result/medical prescription information or the like functions as sort of an electric clinical recording. Accordingly, even when the patient forgets to confirm the detail of the condition of the disease with the doctor or forgets how to take a drug, the patient can easily obtain the information by inspecting the record of the patient information data base 11. Further, since the past medical care result/medical prescription information is also recorded in the patient information data base 11, it is possible for the patient oneself to use the information for judging one's own physical condition.

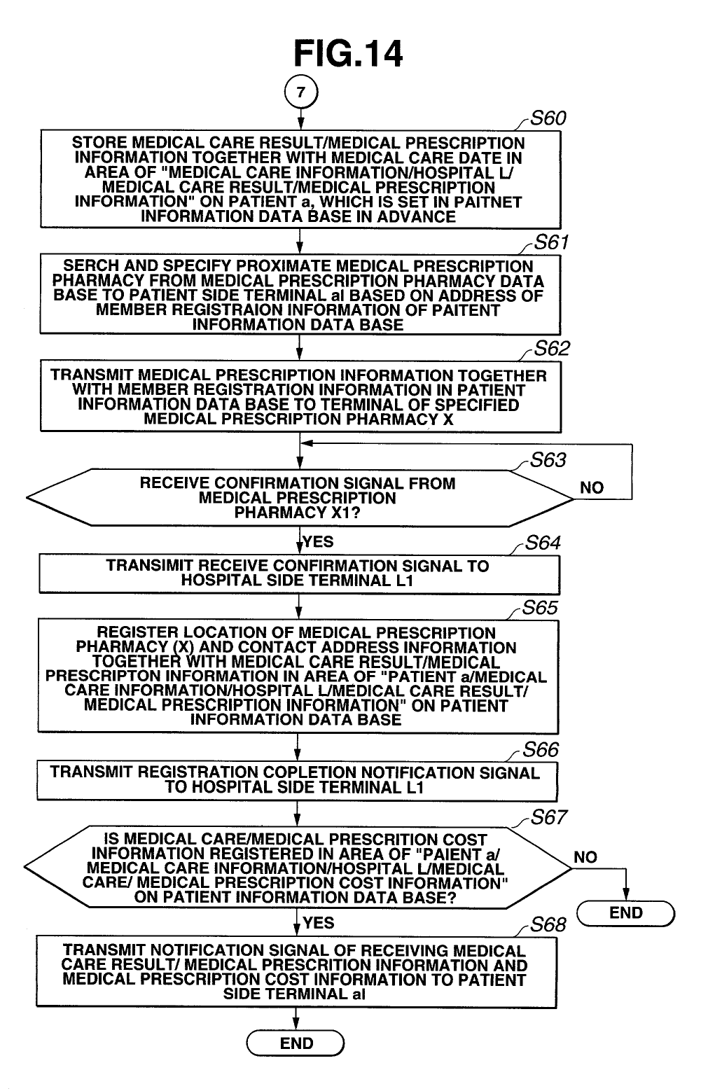

With reference to flowcharts in FIGS. 13 and 14, a procedure to register the medical care result/medical prescription information is explained.

Having access from the hospital side terminal L1 of the hospital L to the host computer 3, at first, the monitor of the host computer 3 indicates the “LOG IN” screen M1 as shown in FIG. 18. Then, the USER ID and the PASSWORD for the hospital, which are registered in advance, are inputted, such that the USER ID for the hospital is inputted in a window 21 and the PASSWORD of the doctor in charge of the patient is inputted in a window 22.

Then, these USER ID and the PASSWORD for the hospital are transmitted to the host computer 3 as a connection requirement signal. In step S51, the host computer 3 connects the line of the hospital side terminal L1 to the line of the host computer 3 based on the connection requirement signal transmitted from the hospital side terminal L1 to transmit the “patient information data base menu” screen information. After that, the host computer 3 proceeds to step S52 to connect the line of the hospital side terminal L1 to the line of the patient information data base 11.

Then, in step S33, the host computer 3 expects to receive a connection requirement signal to “medical care result/medical prescription registration” to be transmitted from the hospital side terminal L1.

On the other hand, receiving the “patient information data base menu” screen information in the hospital side terminal L1, the “patient information data base menu” screen M16 is indicated in the monitor. On this “patient information data base menu” screen M16, in addition to three items including the “member registration information”, the “medical care result/medical prescription registration” and the “medical care/medical prescription cost”, which ate capable of being indicated by the access from the patient side, two items of a “medical care result/medical prescription registration” and a medical care/medical prescription cost”, which are registered by the hospital side, are indicated.

When the hospital side terminal L1 selects the item of the “medical care result/medical prescription registration”, a connection requirement signal to the “medical care result/medical prescription registration” is transmitted to the host computer 3. The host computer 3 receives the connection requirement signal to proceed to step S54. In step S54, the host computer 3 transmits the input screen information of the USER ID for the patient of the patient to be registered to proceed to step S55 and expects to receive of the USER ID for the patient to be transmitted from the hospital side terminal L1.

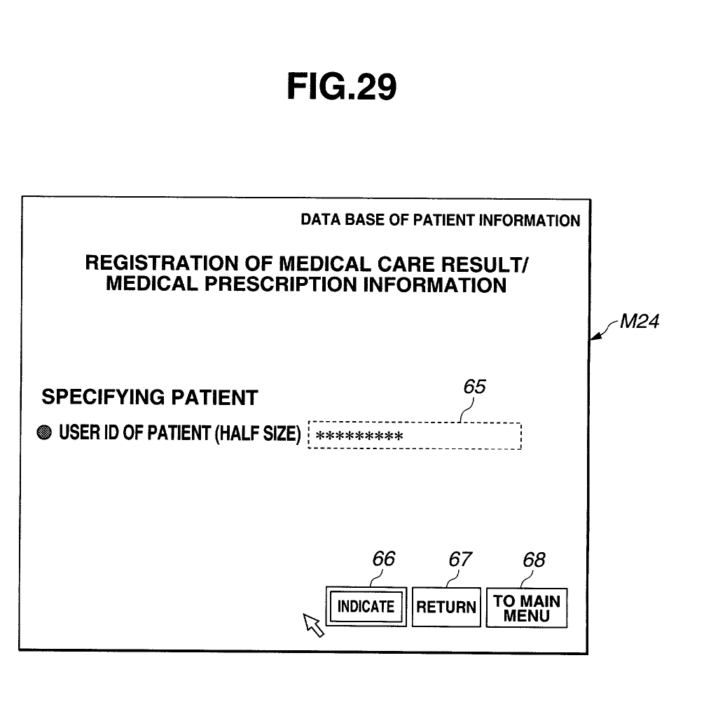

Then, receiving the USER ID for the patient in the hospital side terminal L1, the monitor of the hospital side terminal L1 indicates a “specifying patient” screen M24. As shown in FIG. 29, on the “specifying patient” screen M24, a window 65 to be inputted by the USER ID for the patient to specify the patient, an “indicate” button 66, a “return” button 67 and a “to main menu” button 68 are indicated. Inputting the USER ID for the patient of the specified patient (here, the patient a) in the window 65 to be inputted by the USER ID for the patient and turning on the “indicate” button 66, the USER ID signal for the patient of the specified patient (the patient a) is transmitted to the host computer 3.

The host computer 3 receives the USER ID signal for the patient of this specified patient (the patient a) to proceed to step S56. In step S56 based on inputted the USER ID for the patient of the specified patient (the patient a), the host computer 3 browses in the patient directory Da of respective patients, which is generated in the patient information data base 11 to proceed to step S57. In step S57, the host computer 3 checks whether the USER ID for the patient of the specified patient (the patient a) or not.

If the USER ID is not registered, the routine is ended. If the USER ID is registered, the host computer 3 proceeds to step S58 to transmit the “medical care result/medical prescription information registration” screen information of the patient a to the hospital side terminal L1. Then, the host computer 3 proceeds to step S59 to expect that a registration requirement signal for the medical care result/medical prescription information is transmitted from the hospital side terminal L1.

In this case, as identifying means for specifying the patient, the patient may be specified not by using the USER ID for the patient but by using an administration number which is set between the managing side of the medical care information managing apparatus 2 and the hospital L.

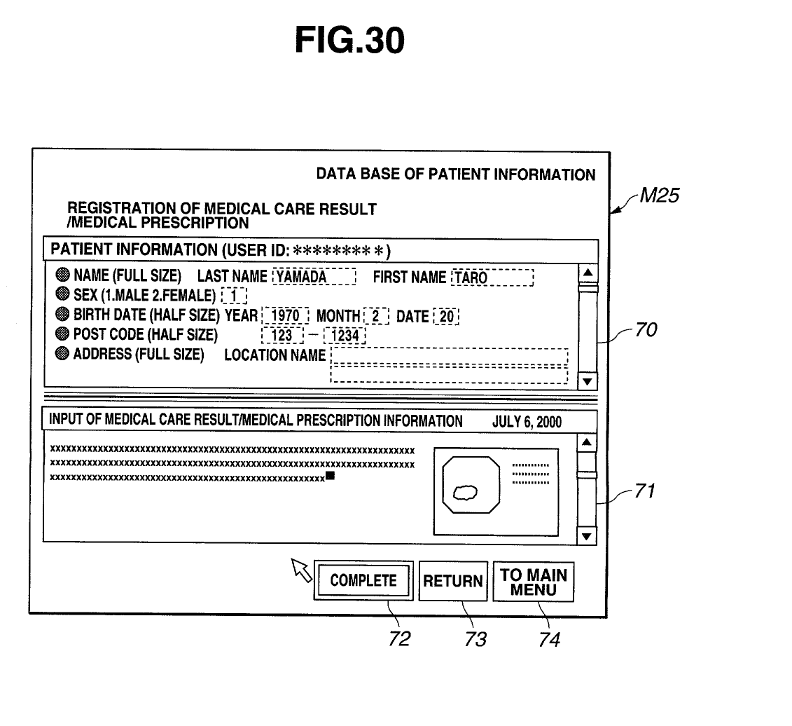

On the other hand, the hospital side terminal L1 receives the patient a's the “medical care result/medical prescription information registration” screen information from the host computer 3. Then, on the monitor of the hospital side terminal L1, a “medical care result/medical prescription information registration” screen M25 is indicated. As shown in FIG. 30, on the “medical care result/medical prescription information registration” screen M25, a window 70 for indicating the patient information, a window 71 into which the medical care result/medical prescription information is to be inputted, a “complete” button 72, a “return” button 73 and “to main menu” button 74 are indicated.

Inputting the medical care result and medical prescription information in the window 71 into which the medical care result/medical prescription information is to be inputted and if necessary, pasting the electrical image such as an endoscopic image, the host computer 3 turns on the “completion” button 72.

Then, a registration requirement signal is transmitted from the hospital side terminal L1 to the host computer 3. The host computer 3 receives this registration requirement signal to proceed to step S60 and generate a new clinical recording file, which stores the medical care result/medical prescription information as well as the medical care data in the medical care result/medical prescription information directory Dme in advance. The medical care result/medical prescription information directory Dme is generated in the hospital directory D1 in the patient directory Da of the patient a, which is generated in the patient information data base 11. Further, when the patient visited the hospital before, a new clinical recording file is not required, and the required items may be added to the past clinical recording file, which has been made.

Then, the host computer 3 proceeds to step S61 to specify the nearest medical prescription pharmacy of the patient side terminal a1 by searching it in the medical prescription pharmacy information data base 13 on the basis of addresses recorded in the member registration information file 112 stored the patient directory Da of the patient information data base 11. Alternatively, the host computer 3 searches a medical prescription pharmacy from in the medical prescription pharmacy information data base 13, and a medical prescription pharmacy is designated by the patient a in advance to specify it.

After that, the host computer 3 proceeds to step S62 to transmit the medical prescription information as well as the member registration information to the specified medical prescription pharmacy side terminal X1 of the specified medical prescription pharmacy (here, for example, a specified medical prescription pharmacy X). The member registration information is recorded in the member registration information file 112 for the patient a in the patient information data base 11. Then, the host computer 3 proceeds to step S63 to expect to receive a receive confirmation signal from a medical prescription pharmacy X1.

When the host computer 3 receives the receive confirmation signal from the medical prescription pharmacy X1 to proceed to step S64. Instep S64, the host computer 3 transmits the receive confirmation signal to the hospital side terminal L1 to proceed to step S65. Then, in step S65, the host computer 3 registers a location and the contact address of the medical prescription pharmacy, which transmits the medical prescription information, in a clinical recording file. The clinical recording file stores the medical care result/medical prescription information in step S60 in advance in the medical care result/a medical prescription information directory Dme of the hospital directory D1 of the hospital L, which is generated in the patient directory Da of the patient a of the patient information data base 11.

Proceeding to step S66, the host computer 3 transmits a registration completion notification signal to the hospital side terminal L1. Receiving the registration completion notification signal in the hospital side terminal L1, the monitor of the hospital side terminal L1 indicates a registration completion” screen M26. The hospital L confirms this screen to confirm the medical result of the patient a or the like is registered in the patient information data base 11. Thus, a registration procedure of the medical result information and the medical prescription information for the patient a in the hospital L is completed.

On the other hand, in the host computer 3, the program proceeds from step S66 to step S67 to check whether a cost particulars file to record the medical care/medical prescription cost information is registered in the medical care/medical prescription cost information directory Dex of the hospital directory D1 of the hospital L, which is generated in the patient information data base 11.

If the cost particulars file is registered in advance, the routine is ended. If the cost particulars file is not registered, the program proceeds to step S68. Then, the system administrator transmits a nitrification signal of receiving the medical care result/medical prescription information and medical care/medical prescription cost information to the patient side terminal a1 to end the routine.

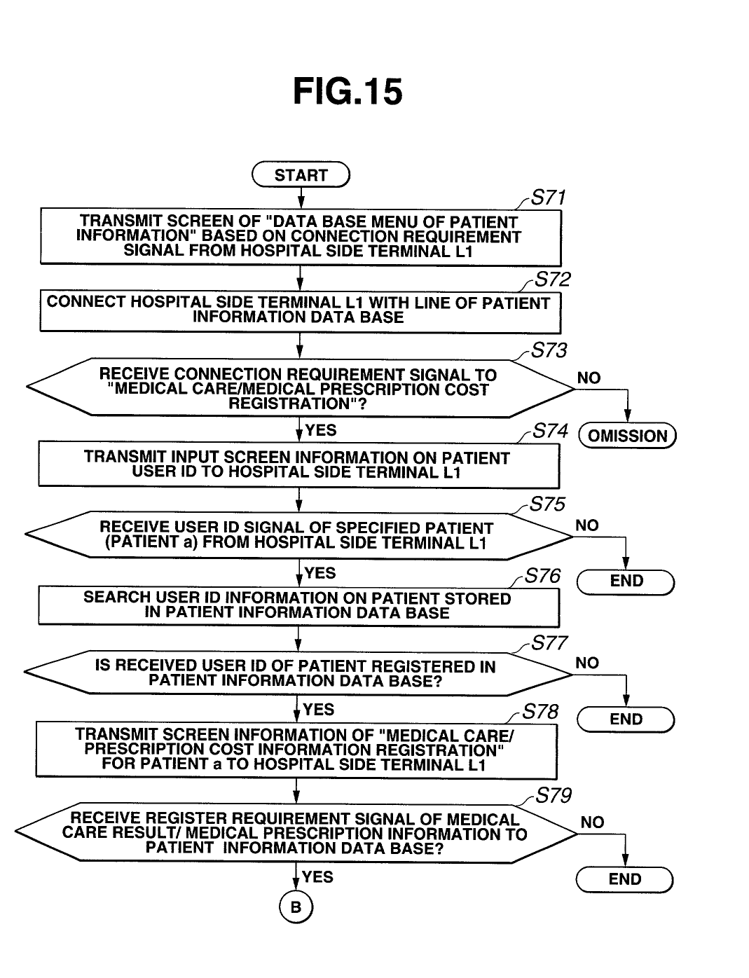

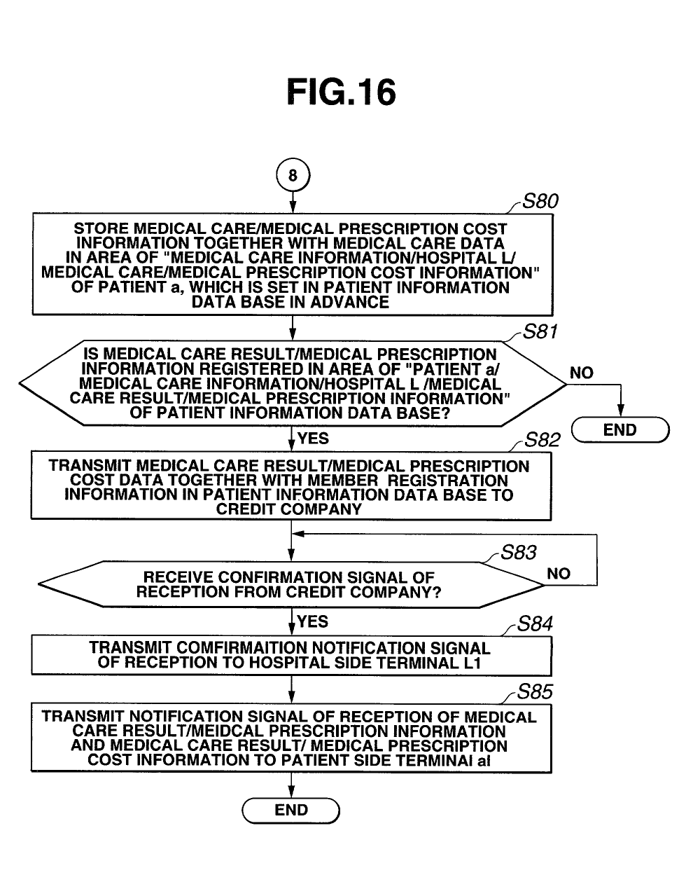

Next, with respect to flow charts in FIGS. 15 and 16, a procedure of a medical care/medical prescription cost registration is explained below.

Having access from the hospital side terminal L1 of the hospital to the host computer 3, at first, the monitor of the hospital side terminal L1 indicates a “LOG IN” screen M1 as shown in FIG. 18. Then, the USER ID for the hospital and the PASSWORD, which are registered in advance, are inputted such that the USER ID for the hospital is inputted in a window 21 and the PASSWORD of the doctor in charge of the patient is inputted in a window 22.

Then, these USER ID and the PASSWORD for the hospital are transmitted to the host computer 3 as a connection requirement signal. In step S71, the host computer 3 connects the line between the hospital side terminal L1 and the host computer 3 on the basis of the connection requirement signal transmitted from the hospital side terminal L1 and transmit the “patient information data base menu” screen information to the hospital side terminal L1. Then, the host computer 3 proceeds to step S72 and connects the line between the hospital side terminal L1 and the patient information data base 11.

Then, in step S73, the host computer 3 expects to receive a connection requirement signal to the “medical care/medical prescription cost registration” to be transmitted from the hospital side terminal L1.

On the other hand, when the hospital side terminal L1 receives the “patient information data base menu” screen information, the “patient information data base menu” screen M16 is indicated on the monitor of the hospital side terminal L1. Selecting the item of the “medical care/medical prescription cost registration” from this menu, a connection requirement signal to the “medical care/medical prescription cost registration” is transmitted to the host computer 3. The host computer 3 receives this signal to proceed to step S74 and transmits the input screen information of the USER ID for the patient of the patient to be registered to proceed to step S75. Then, the host computer 3 expects to receive the USER ID for the patient of the specified patient (here, the patient a) to be transmitted from the hospital side terminal L1.

On the other hand, when the hospital side terminal L1 receives the input screen information of the USER ID for the patient, a “specifying patient” screen M27 is indicated on the monitor of the hospital side terminal L1. Since this “specifying patient” screen M27 is identical with the “specifying patient” screen M24 shown in FIG. 29, the reference numerals used in the “specifying patient” screen M24 in FIG. 29 are used to explain the input operation of the screen M27.

Inputting the USER ID for the patient of the specified patient (here, the patient a) in the window 65 into which the USER ID is to be inputted, which is indicated on the “specifying patient” screen M27 and turning on the “indicate” button 66, the USER ID for the patient of the specified patient (the patient a) is transmitted to the host computer 3.

The host computer 3 receives this USER ID for the patient of the specified patient (the patient a) to proceed to step S76 and searches in the patient directory Da of respective patients, which is generated in the patient information data base 11 on the basis of the inputted USER ID for the patient of the specified patient (the patient a). Then, the host computer 3 proceeds to step S77 to check whether the USER ID for the patient of the specified patient (the patient a) is registered in the directory Da or not.

If it is not registered, the routine is ended. If it is registered, the program proceeds to step S78 to transmit the “medical care/medical prescription cost registration” screen information of the patient a to the hospital side terminal L1 and proceeds to step S79 to expect to receive a registration requirement signal for the medical care/medical prescription cost information to be transmitted from the hospital side terminal L1.

Also in this case, as identifying means for specifying the patient, the patient may be specified not by using the USER ID for the patient but by using an administration number which is set between the managing side of the medical care information managing apparatus 2 and the hospital L.

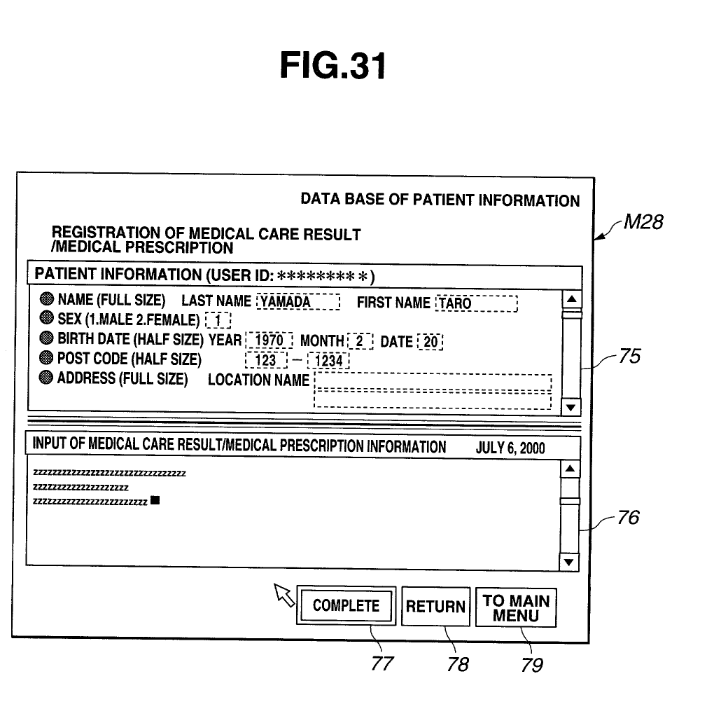

On the other hand, the hospital side terminal L1 receives the “medical care/medical prescription cost registration” screen information of the patient a from the host computer 3 and the “medical care/medical prescription cost registration” screen M28 is indicated on the monitor of the hospital side terminal L1. As shown in FIG. 31, on the “medical care/medical prescription cost registration” screen M28, a window 75 for indicating the patient information, a window 76 to be inputted by the medical care/medical prescription cost, a “completion” button 77, a “return” button 78 and a “to main menu” button 79 are indicated.

Then, the medical care cost and the medical prescription cost are inputted in the window 76 to be inputted by the medical care/medical prescription cost and the “completion” button 77 is turned on.

Accordingly, a registration requirement signal is transmitted from the hospital side terminal L1 to the host computer 3. The host computer 3 receives this registration requirement signal to proceed to step S80 and generates a new cost particulars file, which stores the medical care date and the medical care cost and the medical prescription cost information in the medical care/a medical prescription cost information directory Dex. The medical care/a medical prescription cost information directory Dex is generated in the hospital directory D1 of the patient directory Da of the patient a, which is generated in the patient information data base 11 in advance. Further, when the patient a visited the hospital before, a new clinical recording is not required, so that the required items may be added to the past clinical recording, which has been made.

Then, the host computer 3 proceeds to step S81 to check whether or not a clinical recording file to record this medical result/medical prescription information is registered in the medical care result/a medical prescription information directory Dme of the hospital directory D1 of the hospital L, which is generated in the patient information data base 11.

Then, if the clinical recording file is registered in advance, the routine is ended. If the clinical recording file is not registered, the host computer 3 proceeds to step S82 to transmit the medical care/medical prescription cost data to the credit company, which the patient a designates, together with the member registration information, which is recorded in the member registration information file 112 for the patient a in the patient information data base 11. Then, the host computer 3 proceeds to step S83 to expect to receive a receive confirmation signal to be transmitted from the credit company.

Receiving the receive confirmation signal from the credit company, the host computer 3 proceeds to step S84 to transmit the receive confirmation signal to the hospital side terminal L1. Receiving the receive confirmation signal in the hospital side terminal L1, the monitor of the hospital side terminal L1 indicates a “registration completion” screen M29. The hospital L confirms this screen to confirm the medical care cost and the medical prescription cost information of the patient a are registered in the patient information data base 11. Thus, a registration procedure of the medical care cost and the medical prescription cost information for the patient a in the hospital L is completed.

On the other hand, in the host computer 3, the program proceeds to step S85. Instep S85, the host computer 3 transmits a notification signal of reception of the medical care result/medical prescription information and the medical care/medical prescription cost information to the patient side terminal a1 in the system administrator. Thus, the routine is ended.

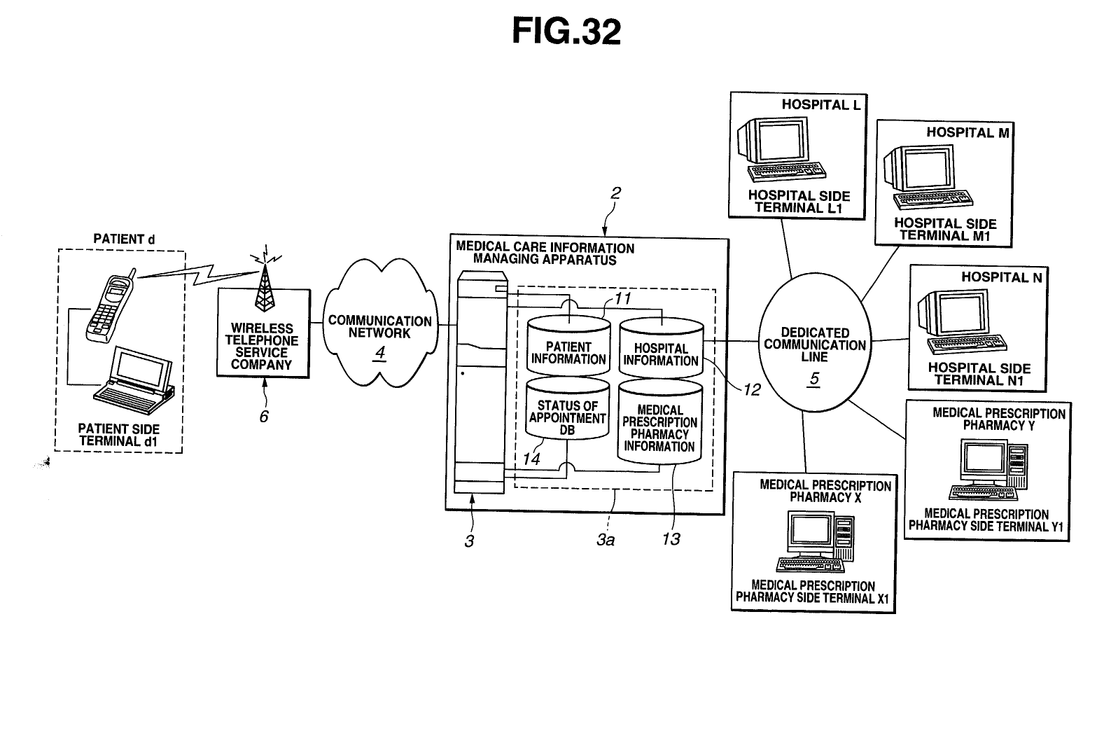

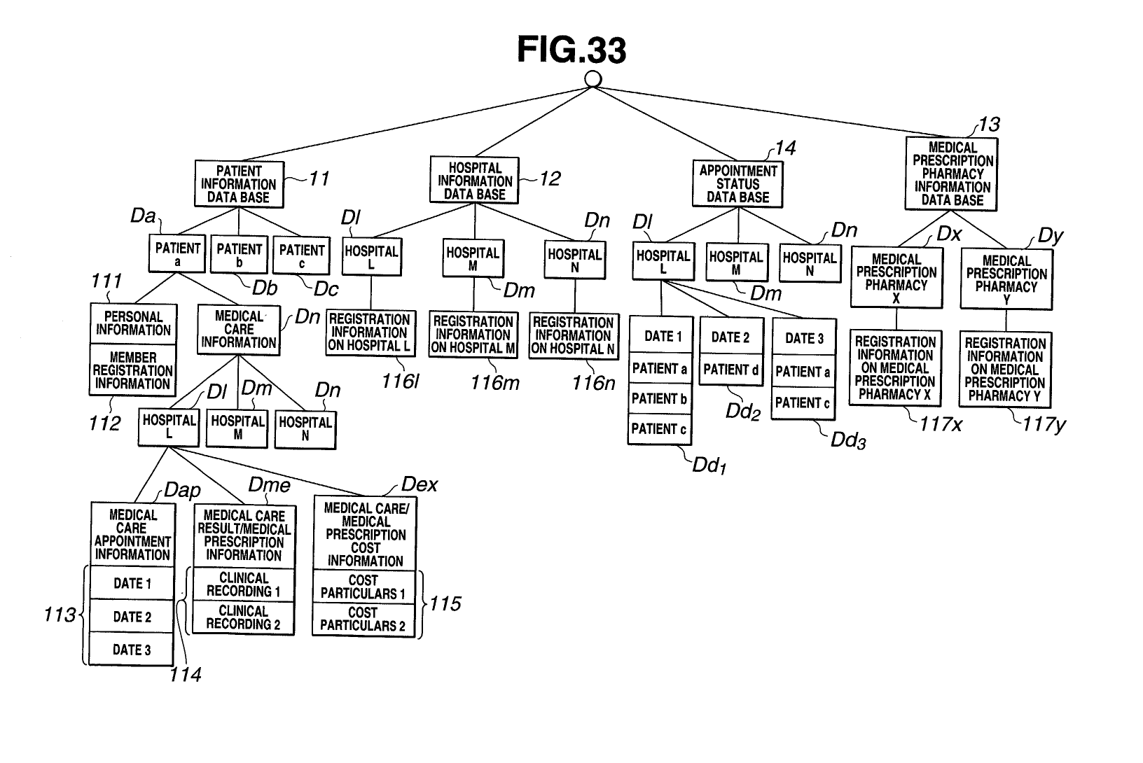

Further, a second embodiment according to the present invention is shown in FIGS. 32 and 33. In the present embodiment, the differences from the first embodiment are explained in detail. In the first embodiment, the appointment status data base 14 are provided in the storing means L2, M2 and N2 of the hospital terminals L1, M1 and N1. However, in the present embodiment, the appointment status data base 14 is provided in the storing means 3a of the host computer 3 of the medical care information managing apparatus 2.

In this case, as shown in FIG. 32, the storing means 3a of the host computer 3 is provided with the patient information data base 11, the hospital information data base 12, the medical prescription pharmacy information data base 13 and the appointment status data bases 14. The directory construction of the inside of the storing means 3a is shown in FIG. 33 and a detailed explanation of the layers in respective directories is omitted.

The hospital directories D1, Dm and Dn of respective hospitals are generated in this appointment status data base 14. The appointment date directories Dd1, Dd2 and Dd3 are generated in these hospital directories D1, Dm and Dn of respective hospitals. In these appointment date directories Dd1, Dd2 and Dd3, the appointment files are generated to register the appointment date.

In this case, since the appointment status data base is managed by the host computer side 3, the access authorities are limited in respective hospitals even to the information, which are registered themselves. The comparison to the table 1 is shown below.

TABLE 2

| | the appointment status data base |
|---|---|
| | of the hospital L of host computer |
| | side |
| USER ID for a patient a | Δ |
| USER ID for a patient c | Δ |
| USER ID for a hospital L | ◯ |
| USER ID for a hospital N | X |

Further, as shown in FIG. 33, if the patient d is a subscriber of a cellular phone or a PHS, the patient side terminal d1 may be connected to a wireless phone 7, such as a cellular phone or a PHS to connect the wireless phone 7 to the communication network 4 via a wireless telephone service company 6, so that the patient is capable of having access to the host computer 3.

As described in the above, in the present embodiment, since the access authority to the patient information data base 11 is given not only to the patient but also to the hospital side, the hospital side, which accepted the appointment by the patient, is capable of referring to the past medical care result/medical prescription information of the patient in advance to perform the medical care without a hitch.

Further, even when the patient cannot go to the regular hospital due to the emergency, if the access authority is given to another hospital, the hospital is capable of having access to the patient information date base 11 to grasp the past condition of the disease. Therefore, even a hospital, which performs a medical care for the patient for the first time, can refer to the past medical care result/medical prescription information in advance, so that they can correctly comprehend the patient's medical history.

Further, in the above described embodiment, a system is configured of the communication network 4, which opens to the outside and the closed dedicated communication line 5. However, the present invention is not limited to this configuration. In this system, the terminal side terminal, the hospital side terminal and the medical prescription pharmacy side terminal may be connected, respectively, via the medical care information managing apparatus so as to communicate with each other.

In these embodiments, the information distribution from the medical care information managing apparatus 2 to the patient side terminals a1, b1, c1 and d1 is not positively performed. However, especially, with respect to the terminals of the medical college and the university hospital, for example, hot news and cases of other hospitals, topics of the medical care or the commercial messages of medical equipment or the like may be distributed.

In this case, in order to facilitate the information exchange between respective institutions, the dedicated communication line may be open without charge or be charged a commission, for example, 500 yen per one appointment for the introduction of the patients (appointment) from the outside communication line. Further, the communication line may be open to medical institutions without charge in accordance with a user's register in the sale of product by a medical equipment manufacturer.

In the present invention, the preferred embodiments of the present invention have been described in detail with reference to the accompanying drawings but it is to be understood that the practical arrangement is not limited to these specific embodiments, and that various design changes may be made without departing from the spirit and scope of the present invention.

What is claimed is:

1. A medical care information managing apparatus comprising:
hospital-specific information storing means for storing hospital-specific information;
hospital search requirement receiving means for receiving a search requirement signal for the hospital-specific information which is stored in the hospital-specific information storing means via a communication line;
hospital-specific information searching means for searching the hospital-specific information, which is stored in the hospital-specific information storing means, on the basis of the search requirement signal received by the hospital search requirement receiving means;
hospital-specific information transmitting means for transmitting the result of the search by the hospital-specific information searching means to the origin of the search requirement signal received by the hospital search requirement receiving means via the communication line;
appointment requirement receiving means for receiving an appointment requirement signal for a hospital specified on the basis of the result of the search by the hospital-specific information searching means via the communication line;
appointment processing means for performing appointment processing for a patient for the specified hospital on the basis of the appointment requirement signal received by the appointment requirement receiving means; and
medical care information storing means for storing medical care information created on the basis of medical care provided to the patient for whom the appointment processing is performed by the appointment processing means.

2. The medical care information managing apparatus according to claim 1, wherein:
the hospital-specific information which is stored in the hospital-specific information storing means includes hospital contact information and medical care department information.

3. The medical care information managing apparatus according to claim 1, further comprising:
browse requirement receiving means for receiving a browse requirement signal for the medical care information stored in the medical care information storing means via the communication line; and
medical care information transmitting means for transmitting the medical care information to the origin of the browse requirement signal received by the browse requirement receiving means via the communication line on the basis of the browse requirement signal received by the browse requirement receiving means.

4. The medical care information managing apparatus according to claim 3, further comprising:
origin determining means for determining the origin of the browse requirement signal received by the browse requirement receiving means; and
browse information restricting means for restricting the transmission of the medical care information by the medical care information transmitting means in accordance with the origin determination result of the origin determining means.

5. The medical care information managing apparatus according to claim 1, further comprising:
appointment status information storing means for storing appointment status information on individual patients in a plurality of hospitals.

6. The medical care information managing apparatus according to claim 5, wherein:
the appointment processing means transmits the appointment requirement signal to the appointment status information storing means via the communication line on the basis of the appointment requirement signal for the specified hospital.

7. A medical care information managing system comprising:
hospital-specific information storing means for storing information specific to a hospital;
search requirement input means for inputting a search requirement signal for the hospital-specific information stored in the hospital-specific information storing means;
hospital search requirement receiving means for receiving the search requirement signal input from the search requirement input means via a communication line;
hospital-specific information 'searching means for searching the hospital-specific information stored in the hospital-specific information storing means on the basis of the search requirement signal received by the hospital search requirement receiving means;
hospital-specific information transmitting means for transmitting the result of the search by the hospital-specific information searching means to the origin of the search requirement signal received by the hospital search requirement receiving means via the communication line;
appointment requirement input means for inputting an appointment requirement signal to a hospital which is specified on the basis of the search result transmitted by the hospital-specific information transmitting means;
appointment requirement receiving means for receiving the appointment requirement signal input by the appointment requirement input means via the communication line;
appointment processing means for performing appointment processing for a patient for the specified hospital on the basis of the appointment requirement signal received by the appointment requirement receiving means; and
medical care information storing means for storing medical care information created on the basis of medical care provided to the patient for whom the appointment processing is performed by the appointment processing means.

8. The medical care information managing system according to claim 7, wherein:
the hospital-specific information stored in the hospital-specific information storing means includes hospital contact information and medical care department information.

9. The medical care information managing system according to claim 7, further comprising:
browse requirement receiving means for receiving a browse requirement signal for the medical care information stored in the medical care information storing means via a communication line; and
medical care information transmitting means for transmitting the medical care information to the origin of the browse requirement signal received by the browse requirement receiving means via the communication line on the basis of the browse requirement signal received by the browse requirement receiving means.

10. The medical care information managing system according to claim 9, further comprising:
origin determining means for determining the origin of the browse requirement signal received by the browse requirement receiving means; and
browse information restricting means for restricting the transmission of the medical care information by the medical care information transmitting means in accordance with the origin determination result of the origin determining means.

11. The medical care information managing system according to claim 7, further comprising:
appointment status information storing means for storing appointment status information on individual patients in a plurality of hospitals.

12. The medical care information managing system according to claim 11, wherein:
the appointment processing means comprises:
appointment status information obtaining means for obtaining the appointment status information on the specified hospital from the appointment information storing means via the communication line on the basis of the appointment requirement signal for the specified hospital, which is received by the appointment requirement receiving means.

13. The medical care information managing system according to claim 12, wherein:
the appointment processing means further comprises;
appointment possibility determining means for determining whether or not an appointment can be made, on the basis of the appointment requirement information which is included in the appointment requirement signal received by the appointment requirement receiving means and the appointment status information on the specified hospital, which is obtained by the appointment status information obtaining means; and
appointment requirement information adding means for adding the appointment requirement information to the appointment status information stored in the appointment status information storing means when an appointment is possible as a result of the determination by the appointment possibility determining means.

14. A medical care information managing method comprising:
a search requirement inputting step for inputting a search requirement signal for hospital-specific information stored in hospital-specific information storing means;
a hospital search requirement receiving step for receiving the search requirement signal input in the search requirement inputting step via a communication line;
a hospital-specific information searching step for searching the hospital-specific information stored in the hospital-specific information storing means on the basis of the search requirement signal received in the hospital search requirement receiving step;
a hospital-specific information transmitting step for transmitting the result of the search in the hospital-specific information searching step to the origin of the search requirement signal via the communication line;
an appointment requirement inputting step for inputting an appointment requirement signal to a hospital specified on the basis of the search result transmitted in the hospital-specific information transmitting step;
an appointment requirement receiving step for receiving the appointment requirement signal input in the appointment requirement inputting step via the communication line;
an appointment processing step for performing appointment processing for a patient for the specified hospital on the basis of the appointment requirement signal received in the appointment requirement receiving step; and
a medical care information storing step for storing medical care information created on the basis of a medical care for the patient for whom the appointment processing is performed in the appointment processing step.

15. The medical care information managing method according to claim 14, wherein:
the hospital-specific information stored in the hospital-specific information storing means includes hospital contact information and medical care department information.

16. The medical care information managing method according to claim 14, further comprising:
a browse requirement receiving step for receiving a browse requirement signal for the medical care information stored in the medical care information storing step via the communication line; and
a medical care information transmitting step for transmitting the medical care information to the origin of the browse requirement signal received in the browse requirement receiving step via the communication line on the basis of the browse requirement signal received in the browse requirement receiving step.

17. The medical care information managing method according to claim 16, further comprising:
an origin determining step for determining the origin of the browse requirement signal received in the browse requirement receiving step; and
a browse information restricting step for restricting the transmission of the medical care information in the medical care information transmitting step in accordance with the origin determination result in the origin determining step.

18. The medical care information managing method according to claim 14, further comprising:
an appointment status information storing step for storing appointment status information on individual patients in a plurality of hospitals.

19. The medical care information managing method according to claim 18, wherein:
the appointment processing step comprises:
an appointment status information obtaining step for obtaining the appointment status information on the specified hospital, which is stored in the appointment information storing step, via the communication line on the basis of the appointment requirement signal for the specified hospital, which is received in the appointment requirement receiving step.

20. The medical care information managing method according to claim 19, wherein:
the appointment processing step further comprises;
an appointment possibility determining step for determining whether or not an appointment can be made, on the basis of the appointment requirement information which is included in the appointment requirement signal received in the appointment requirement receiving step and the appointment status information on the specified hospital, which is obtained in the appointment state information obtaining step; and
an appointment requirement information adding step for adding the appointment requirement information to the appointment state information stored in the appointment status information storing step when an appointment is possible as a result of the determination in the appointment possibility determining step.
